(19) United States
(12) Patent Application Publication
(10) Pub. No.: US 2004/0162076 A1
(43) Pub. Date: Aug. 19, 2004

(54) System and method for simplified secure universal access and control of remote networked electronic resources for the purposes of assigning and coordinationg complex electronic tasks

(76) Inventors: Atul Chowdry, Kendall Park, NJ (US); Vijay Hargundas Khanchandani, Monmouth Junction, NJ (US); Joseph Gerard Marceau, Ashburn, VA (US)

Correspondence Address: JONES DAY, 222 EAST 41ST ST, NEW YORK, NY, 10017, US

(21) Appl. No.: 10/368,059

(22) Filed: Feb. 14, 2003

(51) Int. Cl. H04Q 7/20

(52) U.S. Cl. 455/445; 455/403

(57) ABSTRACT

A system and method are disclosed for accessing resources located on (or accessible from) a remote computer. In a preferred embodiment, a proxy server is adapted to facilitate communication between the remote computer and a user's wireless or other device. Both the remote computer and the wireless device preferably derive a DNS entry for the proxy server from a remote ID assigned to the remote computer and establish an HTTP connection with the proxy server. The remote computer preferably selects DNS entries for the proxy server that include randomly chosen DNS host names each of which resolve to the proxy server's IP address. The proxy server is adapted to forward messages from the wireless device to the remote computer and from the remote computer to the wireless device via the HTTP connection. Each message is preferably encrypted so that it cannot be decrypted by the proxy server.

### BACKGROUND OF THE INVENTION

Over 40 million employees in the United States travel for business at least one day a week. At meetings and trade shows, in hotel rooms and conference centers, these professionals need access to critical business documents residing on their enterprise computer systems or home or office personal computers. In the past, remote access to such documents has been limited and inconvenient.

One way to ensure access to all necessary documents is simply to bring them along, electronically or in hard copy. But multiple hard copies quickly become heavy and unmanageable. And documents stored on a laptop hard drive, although sometimes suitable for display using presentation software, are difficult to print and distribute unless a compatible printer is available.

To alleviate this difficulty, some systems have been developed to provide traveling professionals with remote document access. These proposed systems, however, suffer from significant drawbacks.

In one proposed system, marketed under the name Citrix®, the user is presented with a “virtual image” of the user's desktop from which he or she may access documents and applications stored on a remote server. But although this system provides access to certain system files, connectivity is often limited to personal or laptop computers logging on via the Internet. And even where mobile computing devices can connect to the server, they require additional functionality to properly display and manipulate the “virtual image” presented.

Further, in order to print or transmit a file, the user must remotely launch and manipulate a suitable desktop application. Thus, for example, to send a file via e-mail, the user must remotely launch an e-mail application (e.g., Outlook®) and manually manipulate the application via its user interface to transmit the e-mail. Similarly, to print a file to a local or network printer, the user must launch a suitable word processing program. Moreover, the target printer must be compatible with drivers loaded on the Citrix® server.

Other systems for providing remote document access employ proxy-based systems that broker connections between a client and a controlled remote computer. One such solution, marketed under the name GoToMyPC™, requires a user to navigate to a Web site and establish a secure HTTPS connection, currently unavailable on most wireless devices. The system then asks the user for a first ID and password to log into the GoToMyPC™ service. The service then generates a unique session ID, provides both computers with a session ID and the address of a proxy server via which the user should communicate with the remote computer. At this point, the system further requires the PC and user's device to establish another connection with a separate proxy server. Finally, the user must log in to their PC using their ID and password. This system also suffers from the need to remotely launch and manipulate desktop applications from the remote device.

Another drawback of this system is that the entity that operates the proxy server provides the secret key, or seed to generate the secret key, used to encrypt information between the user's device and the remote computer. Accordingly the user's communications with the remote computer may, at least in theory, be decrypted by the service provider This diminishes system security and provides an additional point of vulnerability at which user communications may be intercepted.

Another proxy-based system, System SEVEN™, requires that data sent between a remote device and a personal computer, or vice versa, be decrypted and forward by the proxy. This reduces data security by creating a security “air-gap” on the system doing the conversion. Furthermore, this system also requires remote application connectivity and manipulation.

The above systems also require the user to use the access device as a remote keyboard, mouse, and display for the computer to which they are connecting. Wireless devices, however, traditionally provide much smaller displays, and more limited keypad or other data input mechanisms than the remote computer being manipulated. Furthermore, mouse operation on a wireless device can be very cumbersome. These factors combine to make such systems extremely difficult to use from most wireless devices.

Yet another system for providing remote document access is described in U.S. Pat. No. 6,487,189 to Eldridge et al. In Eldridge et al., a token or reference is defined for each stored document that identifies the document and its location, i.e., the computing device on which the document is stored. When a user requests that a service be performed with respect to a document (e.g., to e-mail the document), the document's token is transmitted to a token-enabled server which may retrieve the document and perform the service.

Because the system is token based, however, it requires a special-purpose token-enabled server to process user requests. Additionally, since each token represents both a document name and location, token values must be updated each time a file is moved from one location to another, significantly increasing system overhead. Moreover, updated token information must be provided to token-enabled devices that store tokens which have been modified, further increasing system overhead.

In addition, this system requires that all token-enabled devices with access to system documents be trusted. This creates security and management difficulties, especially as system scale is increased, and limits the solution to closed-network type environments. Furthermore, this system, and the others described above, fail to adequately consider the limitations of current wireless devices and do not optimally allocate system processing to most efficiently provide user services in a manner that enhances the user's experience.

### SUMMARY OF THE INVENTION

A system and method are disclosed for accessing resources located on (or accessible from) a remote computer. In a preferred embodiment, a proxy server is provided that is adapted to facilitate communication between the remote computer and a wireless or other device in possession of a user. Both the remote computer and the wireless device preferably derive a DNS entry for the proxy server from a remote ID (RID) assigned to the remote computer and establish an HTTP connection with the proxy server. The remote computer preferably selects DNS entries for the proxy server that include randomly chosen DNS host names each of which resolve to the proxy server's IP address to eliminate patterns of accessing a particular DNS entry.

The proxy server is adapted to forward messages from the wireless device to the remote computer and from the remote computer to the wireless device via the HTTP connection. Each message is preferably encrypted so that it cannot be decrypted by the proxy server.

Using an interface on the wireless device, the user is preferably able to log on to the remote computer via the proxy server without having to enter an IP address or multiple logon IDs and passwords. Once logged on, the user may query the remote computer via the proxy server for a list of available resources and services. These services may preferably include e-mailing a selected resource to a specified destination, printing a selected resource to a specified public or other printer, and faxing a selected resource to a specified fax machine. Additional system services may allow a user to identify nearby printers and convert or format a resource before e-mailing or printing. User accounts are preferably automatically debited when services are provided and may be automatically replenished if account balances fall below a predetermined amount.

Moreover, the communications infrastructure of the present system and method and simplified connection process enabled by the RID may be utilized to facilitate communication between a wireless device and any internet-connected device (such as, for example, a home appliance) and access to any resources or services provided by such devices. The simplified connection process enabled by the RID, and in particular those aspects of the process in which a numeric string is parsed to derive a DNS entry, may also be utilized generally to facilitate access to Internet addresses especially from devices that provide limited keypads and other input mechanisms which make entry of non-numeric characters and other non-numeric user input inconvenient.

In a preferred embodiment, system printing services include a service in which printer ready bits are transmitted from the remote computer to the wireless device via the proxy server. The printer ready bits are compressed before transmission and divided into blocks whose size is a function of certain physical parameters of the wireless device and network connection. The wireless device receives the compressed blocks and creates a first processing thread for downloading and storing the printer ready bits in the wireless device's memory and a second processing thread for decompressing the stored compressed printer ready bits and wirelessly streaming the decompressed printer ready bits to a wireless printer for printing.

The present system and method eliminate the need for the wireless device to store special printer drivers or have adequate processing power and memory to perform document conversion on the wireless device itself The system may be adapted to handle any size print job and perform any size conversion, since it is not limited by the wireless device's capabilities. Moreover, the system leverages the significantly greater computing power of the remote computer (which may, for example, have multiple GHz CPU's and GB's of RAM as compared to the 20-30 MHz processor and 256 k free RAM of current wireless devices) in a variety of ways to increase system performance.

Public printing services also include a service in which the wireless device can determine its current zip code or other postal or location code using global positioning and request a list of nearby printers. The list may also contain printer information, such as costs and hours of operation, and may allow the user to select one printer for a print job. Additionally, this service can provide directions from the users current location to a specified printer for ease of document retrieval.

The remote computer is preferably adapted to transmit a confirmation message to the wireless device upon completion or failure of a service request and other specified events. In a preferred embodiment, the system is adapted to determine when a service is not likely to be completed before the connection between the wireless device and proxy server is dropped. In such cases, an interim message is transmitted via the proxy server to confirm that the service is in process, and a subsequent confirmation message is transmitted to the wireless device via an SMS gateway or alternative means when the service is completed.

The remote computer is also preferably enabled to dynamically determine maximum time periods for responding to polling requests from the remote computer. This minimizes system overhead and increases the number of connections a proxy server may maintain.

In one aspect, the present invention is directed to a method for facilitating user access from a wireless device to one or more resources stored on or accessible from a remote computing device, the computing device comprising: one or more input devices; one or more desktop applications, each desktop application comprising a user interface for accessing functionality associated with the application via at least one of the one or more input devices; and a software program comprising a communication component having no user interface accessible via the one or more input devices and being accessible solely via communication with a proxy server; the method comprising:

transmitting a resource list from the computing device to the wireless device via a proxy server, the resource list comprising identifiers for each of one or more resources that identify the resource without identifying the location where the resource is stored;

transmitting a message from the wireless device to the computing device via the proxy server, the message representing a request for a service in connection with a selected resource; and

performing the requested service without launching the one or more desktop applications.

In another aspect of the present invention, the service is to transmit the selected resource via electronic mail to a destination address.

In another aspect of the present invention, the method further comprises the steps of:

the communication component retrieving the selected resource, constructing an electronic mail message including the selected resource, and transmitting the electronic mail message to the destination address.

In another aspect of the present invention the method further comprises the steps of:

converting the selected resource from a first format to a second format; and the communication component constructing an electronic mail message including the selected resource in the second format, and transmitting the electronic mail message to the destination address.

In another aspect of the present invention, the service is to print the resource at a printer accessible by the computing device.

In another aspect of the present invention, the printer is a local printer accessible by the computing device.

In another aspect of the present invention, the printer is a network printer accessible by the computing device via a network.

In another aspect of the present invention, the method further comprises the steps of:

the communication component retrieving the selected resource and forwarding it to a print service component;

the print service component formatting the resource for printing;

the print service component transmitting the formatted resource to the computing device; and

the computing device transmitting the formatted resource to the printer for printing.

In another aspect of the present invention, the service is to print the resource at a public printer.

In another aspect of the present invention, the method further comprises the steps of:

the communication component retrieving the selected resource and forwarding it to a print services component;

the print service component formatting the resource for printing; and

the print service component transmitting the formatted resource to a public printer.

In another aspect of the present invention, the method further comprises the steps of:

determining the location of the wireless device;

identifying one or more public printers within a predetermined distance of the determined location;

selecting by the user a public printer from the identified one or more public printers; and

the print service component transmitting the formatted resource to the selected public printer.

In another aspect of the present invention, the location of the wireless computing device is determined using global positioning means.

In another aspect of the present invention, the location of the wireless computing device is determined using user input.

In another aspect of the present invention, the service is to print the resource at a printer accessible by the wireless device.

In another aspect of the present invention, the printer is a wireless printer.

In another aspect of the present invention, the printer is an infrared enabled printer.

In another aspect of the present invention, the printer is a radio frequency enabled printer.

In another aspect of the present invention, the printer is accessible via a wired connection to the wireless device.

In another aspect of the present invention, the method further comprises the steps of:

the communication component retrieving the selected resource and forwarding it to a print service component;

the print service component formatting the resource for printing;

the print service component transmitting the formatted resource to the computing device;

the computing device transmitting the formatted resource to the wireless device via the proxy server; and

the wireless device transmitting the formatted resource to the printer.

In another aspect of the present invention, the service is to transmit the resource as a fax to a fax machine.

In another aspect of the present invention, the wireless device communicates with the proxy server via an HTTP connection.

In another aspect of the present invention, the computing device communicates with the proxy server via an HTTP connection.

In another aspect of the present invention, the method further comprises the steps of:

the computing device periodically polling the proxy server;

the proxy server determining whether data intended for the computing device has been received from the wireless device;

if data intended for the computing device has been received, immediately transmitting said data in a polling response to the computing device; and

if data intended for the computing device has not been received, transmitting an empty polling response to the computing device after some predetermined time.

In another aspect of the present invention, the method further comprises the steps of:

the wireless device waiting for a response from the computing device;

determining whether data intended for the wireless device will be ready for transmission to the wireless device before the connection between the wireless device and the proxy server is closed;

if data intended for the wireless device will be ready for transmission before the connection between the wireless device and the proxy server will be closed, transmitting the data from the computing device to the wireless device via the proxy server; and

if data intended for the wireless device will be ready for transmission after the connection between the wireless device and the proxy server will be closed, transmitting a message from the computing device to the wireless device via the proxy server, said message containing an in progress notification.

In another aspect of the present invention, the method further comprises:

establishing an account for the user;

depositing value in the account;

billing said account for services provided;

monitoring the value remaining in the account; and

replenishing the account when the remaining value falls below a predetermined amount.

In another aspect of the present invention, the step of replenishing comprises automatically replenishing the account by charging a credit card of the user.

In another aspect of the present invention, the step of replenishing comprises automatically replenishing the account by withdrawing funds from an account maintained by the user with a financial institution.

In another aspect of the present invention, the step of replenishing comprises transmitting an invoice to the user and receiving funds for deposit in the account.

In another aspect of the present invention, the method further comprises:

identifying a vendor that participated in providing a requested service;

automatically crediting an account of the vendor for its participation.

In another aspect of the present invention, the step of identifying a vendor comprises identifying the vendor associated with a printer ID of a printer to which a print job is transmitted.

In another aspect, the present invention is directed to a method for transmitting data to a wireless device comprising:

dividing the data into blocks, each block having a size, the size being determined as a function of one or more physical characteristics of the wireless device; and

transmitting the blocks to the wireless device.

In another aspect of the present invention, the blocks are transmitted sequentially.

In another aspect of the present invention, the one or more physical characteristics comprise memory capacity of the wireless device.

In another aspect of the present invention, the data comprises a print job and further comprises the wireless device transmitting printer ready bits derived from the blocks to a printer for printing.

In another aspect of the present invention, the data is compressed before it is divided into blocks, and is decompressed by the wireless device.

In another aspect of the present invention, the wireless device controls delivery of the blocks.

In another aspect of the present invention, the wireless device delays a request for a next block to accept a second transmission, and recommences transmission of the blocks by requesting the next block upon completion of the second transmission.

In another aspect, the present invention is directed to a method for communicating a confirmation message to a wireless device regarding a requested service, comprising:

determining a first time amount, the first time amount representing the time a connection to a wireless device is likely to remain available;

determining a second time amount, the second time amount representing the time it is likely to take to complete the requested service;

if the first time amount is greater than the second time amount, transmitting the confirmation message via the connection to the wireless device; and

if the second time amount is greater than the first time amount, transmitting the confirmation message via an alternate communication means.

In another aspect of the present invention, the alternate communication means is a short message service.

In another aspect, the present invention is directed to a method for increasing the number of connections that can be handled by a proxy server, comprising:

determining a time amount that a connection can remain idle between the proxy server and a computing device;

receiving a polling request from the computing device at the proxy server; and responding to the polling request when the time amount has passed.

In another aspect of the present invention, the step of determining comprises incrementally increasing the time before the proxy server transmits a response to polling requests from the computing device until the delay results in a disconnection.

In another aspect of the present invention, the computing device is assigned a unique numeric identifier comprising a plurality of fields.

In another aspect of the present invention, the user may configure a program on the wireless device to communicate with the computing device via the proxy server without inputting non-numeric characters corresponding to a DNS entry or navigating via a web-based interface using input mechanisms of the wireless device.

In another aspect of the present invention, the user enters the unique numeric identifier on the wireless device during configuration, the identifier being used to derive connection information regarding the proxy server.

In another aspect of the present invention, the unique numeric identifier is used to derive a host name for the proxy server.

In another aspect of the present invention, the unique numeric identifier contains a check sum field.

In another aspect of the present invention, once the program is configured, the user can launch the program and connect to the proxy server via an HTTP connection without:

inputting the unique numeric identifier each time a connection is established;

inputting non-numeric characters corresponding to a DNS entry; or navigating via a web-based interface using the wireless device input mechanisms.

In another aspect, the present invention is directed to a method for connecting a computing device to a proxy server, said computing device being provided with a unique numeric identifier comprising a plurality of fields, the method comprising:

establishing a HTTP connection between the computing device and the proxy server using a DNS entry derived from the plurality of fields and a DNS domain name selected from a plurality of DNS domain names provided to the computing device;

establishing subsequent HTTP connections between the computing device and the proxy server using DNS entries derived from the plurality of fields and others of the DNS domain names provided to the computing device;

wherein each DNS entry resolves to the same proxy server.

In another aspect, the present invention is directed to a method for authenticating a data message transmitted from a wireless device to a computing device via a proxy server, comprising:

using at least a portion of a password entered by a user to generate an encryption key;

encrypting a message with the encryption key;

transmitting the encrypted message from the wireless device to the computing device via the proxy server;

the computing device using the at least a portion of the password to generate a decryption key;

decrypting the encrypted message by the computing device using the decryption key; and

determining if the decrypted message contains valid data.

In another aspect of the present invention, valid data comprises a valid system command at a predefined location in the data message.

In another aspect of the present invention, valid data comprises a valid system command at a predefined location in the data message.

In another aspect, the present invention is directed to a system for facilitating user access to one or more resources, comprising:

a proxy server;

a wireless device adapted to establish a communication link with the proxy server;

a computing device comprising one or more input devices, one or more desktop applications, each desktop application comprising a user interface for accessing functionality associated with the application via at least one of the one or more input devices, and a software program comprising a communication component having no user interface accessible via the one or more input devices and being accessible solely via communication with the proxy server, the computing device being adapted to transmit a resource list to the wireless device via the proxy server, the resource list comprising identifiers for each of one or more resources that identify the resource without identifying the location where the resource is stored and adapted to receive a message from the wireless device via the proxy, the message representing a request for a service in connection with a selected resource.

### BRIEF DESCRIPTION OF THE DRAWINGS

FIG. 1 is a block diagram illustrating one preferred embodiment of the present system and method;

FIG. 2 is a block diagram illustrating aspects of the preferred embodiment of FIG. 1 in more detail;

FIGS. 3A-3B are block diagrams illustrating aspects of the preferred embodiments of FIGS. 1 and 2 in more detail.

FIGS. 4A-4C are a flow diagram illustrating a preferred embodiment for implementing system setup;

FIG. 4D is a block diagram illustrating a preferred embodiment of a remote computer ID (RID);

FIGS. 5A-5C are a flow diagram illustrating aspects of system operation in one preferred embodiment of the present system and method;

FIGS. 6A-6D are a flow diagram illustrating another further aspects of system operation in one preferred embodiment of the present system and method;

FIG. 7A is a block diagram illustrating a preferred embodiment for providing an e-mail service in the present system and method;

FIGS. 7B-C are a flow diagram illustrating aspects of system operation in the preferred embodiment of FIG. 7A;

FIG. 8A is a block diagram illustrating a preferred embodiment for providing an e-mail with conversion service in the present system and method;

FIGS. 8B-C are a flow diagram illustrating aspects of system operation in the preferred embodiment of FIG. 8A

FIG. 9A is a block diagram illustrating a preferred embodiment for providing a public printing service in the present system and method;

FIGS. 9B-C are a flow diagram illustrating aspects of system operation in the preferred embodiment of FIG. 9A.

FIG. 10A is a block diagram illustrating a preferred embodiment for providing a local print service in the present system and method;

FIGS. 10B-C are a flow diagram illustrating aspects of system operation in the preferred embodiment of FIG. 10A;

FIG. 11A is a block diagram illustrating a preferred embodiment for providing wireless print service in the present system and method;

FIGS. 11B-C are a flow diagram illustrating aspects of system operation in the preferred embodiment of FIG. 11A;

FIG. 11D is a composite block/flow diagram illustrating a preferred embodiment for transmitting a print job to a wireless printer via a wireless device;

FIG. 12A is a block diagram illustrating a preferred embodiment for providing a fax service in the present system and method;

FIGS. 12B-C are a flow diagram illustrating aspects of system operation in the preferred embodiment of FIG. 12A;

FIG. 13 is a block diagram illustrating a preferred embodiment of the present system and method suitable for providing an enterprise solution.

### DETAILED DESCRIPTION OF THE PREFERRED EMBODIMENTS

System Architecture

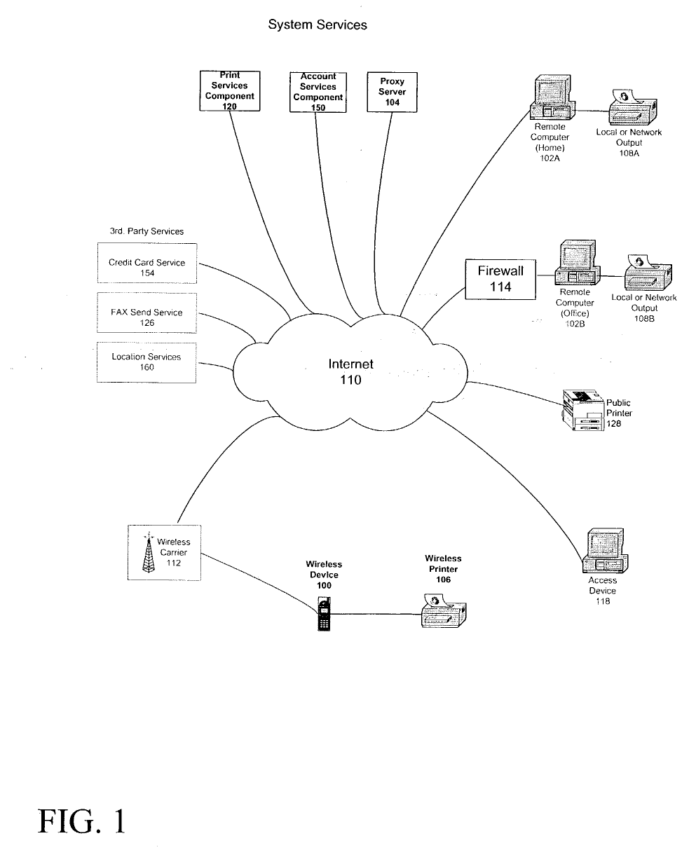

FIG. 1 illustrates one preferred embodiment of the present system. Shown in FIG. 1 is a proxy server 104 adapted to facilitate communication between pairs of devices such as a wireless device 100 and a home or office computer 102A, 102B. Wireless device 100 may, for example, be a cellular phone, personal digital assistant (“PDA”), or other wireless device adapted to connect to the Internet via cellular facilities 112 maintained by a wireless carrier. Remote computer 102 preferably is a personal computer (PC) owned, maintained, or otherwise associated with the user and adapted to connect to the Internet via an Internet service provider (not shown) directly or through a firewall 114. To facilitate description of the present system and method, computing device 102 will be referred to herein as PC 102. Preferred embodiments for establishing communication between a wireless device 100 and a PC 102 via proxy server 104 are described in more detail below.

PC 102 is preferably provided with one or more input/output devices such as a CRT or other suitable screen for viewing output generated by applications running on PC 102 and a keyboard and mouse for inputting data to be processed by such applications. Computer 102 may also be connected to a local or network output device 108 such as a local printer or a printer accessible via a local or wide area network and may similarly be connected to a local or network fax server.

Connections between system components in FIG. 1 are preferably established via the Internet or other suitable network connection. For example, as described below, wireless device 100 and PC 102 each preferably connects to proxy server 104 by establishing a respective HTTP or other suitable connection via the Internet 110.

Also shown in FIG. 1 is a print services component 120 adapted to establish a secure connection with PC 102 and provide printing and related services for files resident on PC 102, as described in more detail below. Such services preferably facilitate document printing in response to user requests at public printers, such as a public printer 128, at local or network printers, such as printers 108, or at wireless printers, such as a printer 106.

Further shown in FIG. 1 is an account manager component 150 adapted to establish, maintain, and monitor user accounts and to respond to queries regarding user-account status. The structure and operation of account manager component 150 is described in more detail below.

Also shown in FIG. 1 are a plurality of third-party services including location services 160, fax send service 126, and credit card services 154. As described below, location services 160 preferably provides location-based services such as identifying and locating nearby printers, fax send service 126 preferably provides services for faxing user documents, and credit card service 154 preferably provides services relating to charging and billing user credit cards.

Also shown in FIG. 1 is an alternative access device 118. In a preferred embodiment, access device 118 may be used as an alternate means for communicating with a PC 102 when, for example, access via a wireless device 100 is inconvenient or impossible.

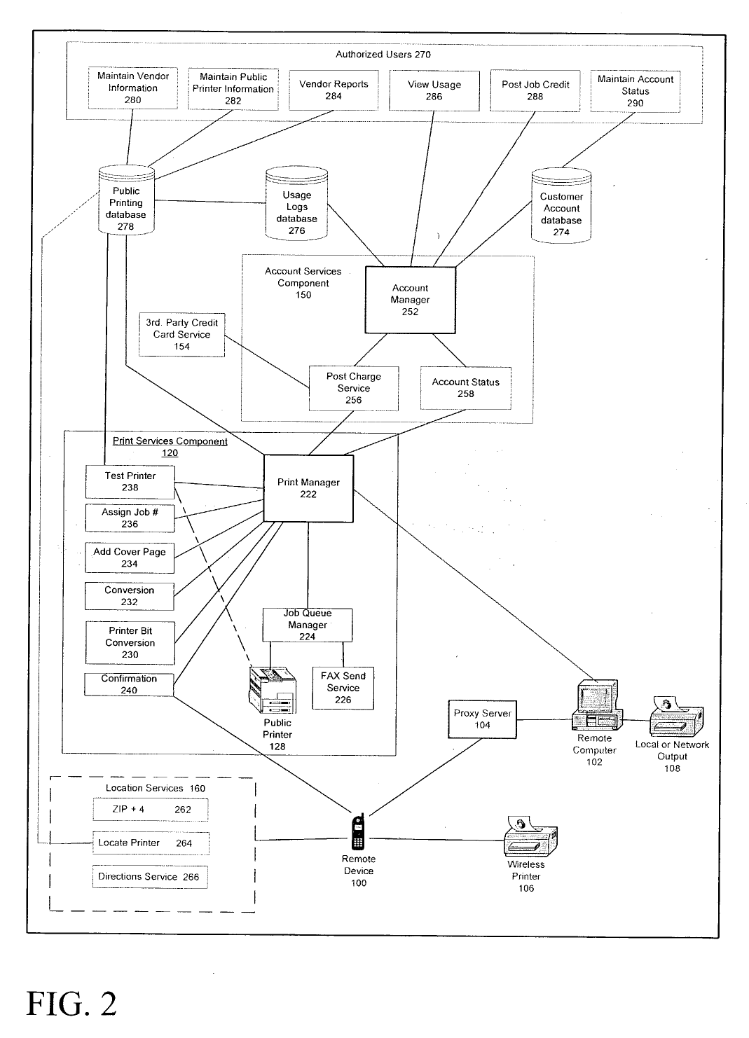

Aspects of the preferred embodiment of FIG. 1 are shown in more detail in FIG. 2. As shown in FIG. 2, print services component 120 preferably comprises service modules accessible by a print manager 222. These service modules preferably include printer bit conversion 230, conversion 232, add cover page 234, assign job number 236, test printer 238, confirmation 240, and job queue manager 224.

As described below, service modules 230-238 are called by print manager 222 when preparing documents in response to a user service request. When a document print or fax request is received from the user, print manager 222 calls assign job number 236 to assign a unique job number to the request. Print manager 222 calls conversion 232 if it is required to convert the document from one format to another, e.g., from Microsoft Word® format to Adobe Acrobat® format. Further, print manager 222 calls add cover page 234 to add a coversheet to a job request for identification purposes at the document destination.

Printer bit conversion 230 maintains a database of device drivers and acceptable format parameters for printers and fax machines available to the user. Print manager 222 calls printer bit conversion 230 to convert documents into an acceptable format for printer such as printers 106, 108 and 128, or to prepare documents for faxing. When a job is ready for printing, it is forwarded by print manager 222 to job queue manager 224 which manages transmission of the printer bits to public printer 128 to ensure that the print job is properly completed. Job queue manager 224 also preferably manages a queue for fax jobs to be processed fax send service 226.

Confirmation 240 is preferably adapted to transmit confirmation messages concerning status of print or fax requests processed by the present system. Test printer 238 is preferably adapted to test the availability and status of public printers 128. Operation of these components is described further below.

FIG. 2 also shows account services component 150 in more detail. Account services component 150 preferably comprises an account manager 252 and a plurality of services including credit card module 154, post charge module 256, and account status module 258. All activity by account services component 150 is preferably logged in a usage log database 276.

Customer account database 274 preferably stores parameters relating to a user account. For example, when a user account is initially set up, the account preferably contains parameters such as account balance, services available to the user, payment method, payment frequency, threshold amount, and replenishment amount.

As described below, print services component 120 preferably requests user account status from account services component 150 before printing or performing other services requested by the user. Further detail concerning this aspect of system operation is described below.

Also shown in FIG. 2 is location services 160. Location services 160 preferably comprises a plurality of user selectable services including current location service 262, locate printer service 264, and directions service 266, the purpose and operation of which are described below.

Also shown in FIG. 2 is public printing database 278. Public printing database 278 preferably maintains a database of all available printer locations, hours of operation, types of printers available, acceptable printer formats for each printer, printer driver details, other printer specific information, and a print job fee schedule for each printer. The print job fee schedule is described in detail below.

FIG. 2 also shows authorized users component 270. Authorized users component 270 preferably comprises a component 280 that provides a means for creating, deleting, maintaining, and updating user account information. Additionally, authorized users component 270 is provided with additional services such as a maintain public printer information component 282, vendor reports component 284, view usage component 286, post job credit component 288, and maintain account status component 290. Maintain printer information component 282 provides a means for a vendor, or other authorized user, to create, delete, update, and maintain information related to any printer, e.g., the vendor name, printer ID, printer type and capabilities, cost for printing, and printer hours of availability. Provide vendor reports component 284 allows a vendor, or other authorized user, to monitor activity for their printers, e.g., total usage for a time period, or total revenue for a location or time period. View usage component 286 provides a means to monitor the activity of the present system and method, e.g., to view services accessed by dollar amount or geographic location, view proxy server activity for load balancing purposes, or to view average usage by dollar amount or time period. As described below, post job credit component 288 provides a means to charge-back or credit a user account for debited services that are incomplete for any reason. Maintain account status component 290 provides a means to add, delete, update, or maintain a user account.

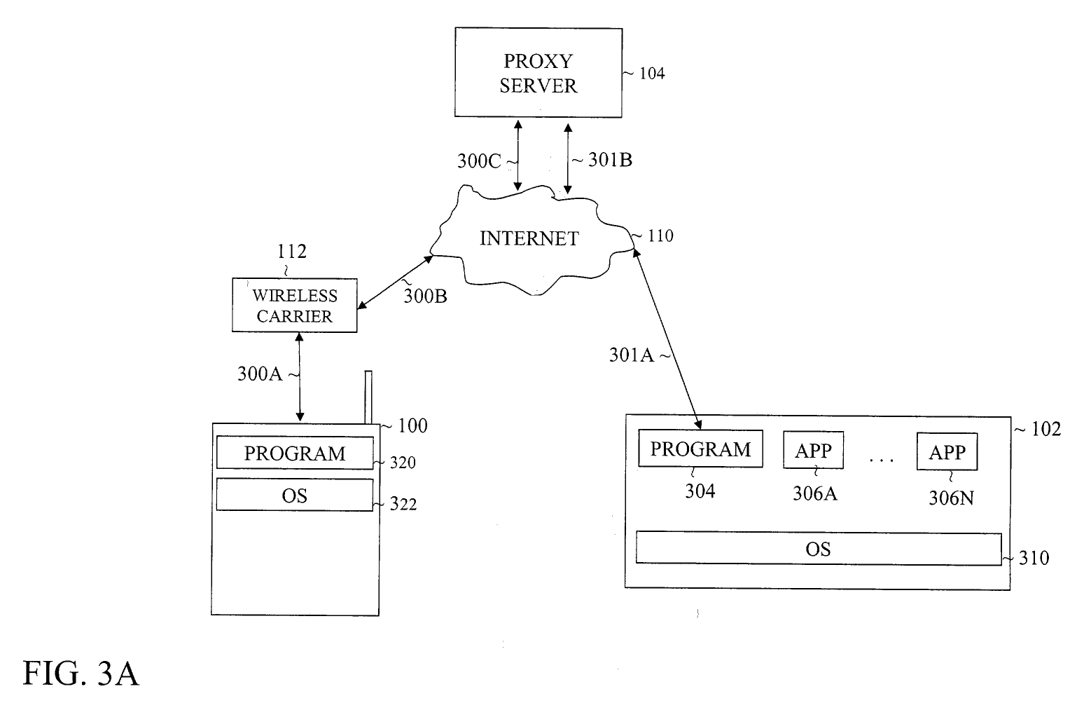

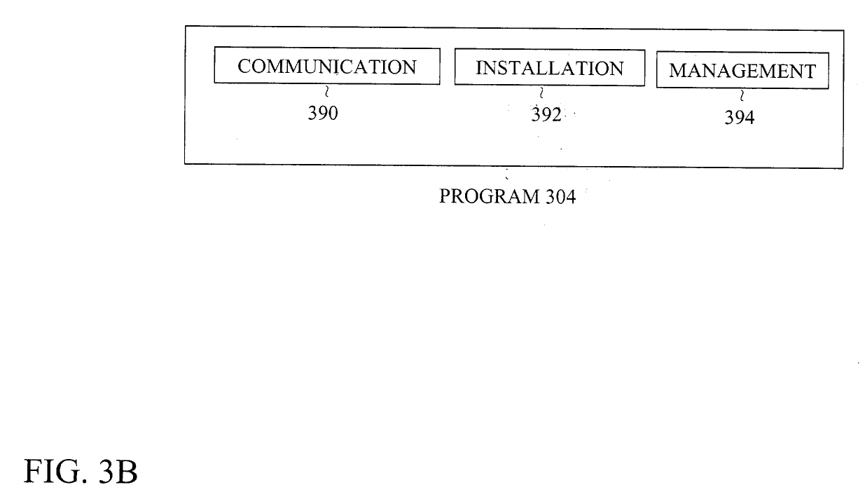

Aspects of the preferred embodiment of FIGS. 1 and 2 are described in more detail in connection with FIG. 3A. As shown in FIG. 3A, wireless device 1100 is preferably provided with a suitable operating system 322. For example, wireless device 100 may be provided with Palm OS®, Windows CE®, or other suitable operating system. Further, wireless device 1100 is preferably loaded with a program 320 adapted to provide particular functionality required for accessing system services, as described in more detail below. In a preferred embodiment, program 320 may be an object-oriented program adapted to run in an appropriate runtime environment such as a Java runtime environment or a BREW environment established on the wireless device.

PC 102 is preferably provided with a suitable operating system 310 and one or more applications 306. For example, PC 102 may preferably be provided with Windows NT®, Windows 2000®, or other suitable operating system. Applications 306 on PC 102 may, for example, include Microsoft Outlook®, Outlook Express®, Microsoft Word®, WordPerfect®, and other applications. Further, PC 102 is preferably loaded with a program 304 adapted to provide particular functionality required for providing system services, as described in more detail below.

In a preferred embodiment program 304 is adapted to run as a background program, i.e., as a daemon or service, and is not provided with a user interface accessible via input/output devices of PC 102. The program is preferably adapted to launch automatically upon bootup of PC 102, and continue running at all times PC 102 remains on. In some embodiments, program 304 may preferably be adapted to launch automatically when the user logs on to PC 102. Alternatively or in addition, the program may also be manually launched by the user.

As shown in FIG. 3B, program 304 preferably comprises a communication component 390 that runs as a daemon process and is adapted to facilitate connections between proxy server 104 and PC 102, as described below. Program 304 further preferably comprises an installation component 392 for installing the program on PC 102 and a management component 394 for providing a user interface for configuring program 304.

Program 304 is preferably adapted to access files and file structure present on PC 102, and comprises functionality for sending e-mail, SMS messages, faxes, or other text based or digital messages via a network interface. Program 304 may further be preferably adapted to access other resources stored locally on PC 102 or accessible from that PC 102. Accessible resources may include information accessible via a network drive, or network file server or stored in one or more databases, contact information, or other data elements or objects to which PC 102 has access. Program 304 is also preferably enabled to send electronic mail messages which may include user customizable content such as subject name, message text, “from ID”, signatures, and attachments. Further, program 304 is preferably adapted to communicate with one or more of applications 306 and operating system 310 on PC 102 to access information such as operating system registry, settings, address book contents, e-mail settings, scheduler contents, and planner contents, and to identify user access limitations. In a preferred embodiment, PC 102 and wireless device 100 are each adapted to establish an HTTP connection with proxy server 104, as described below.

System Setup

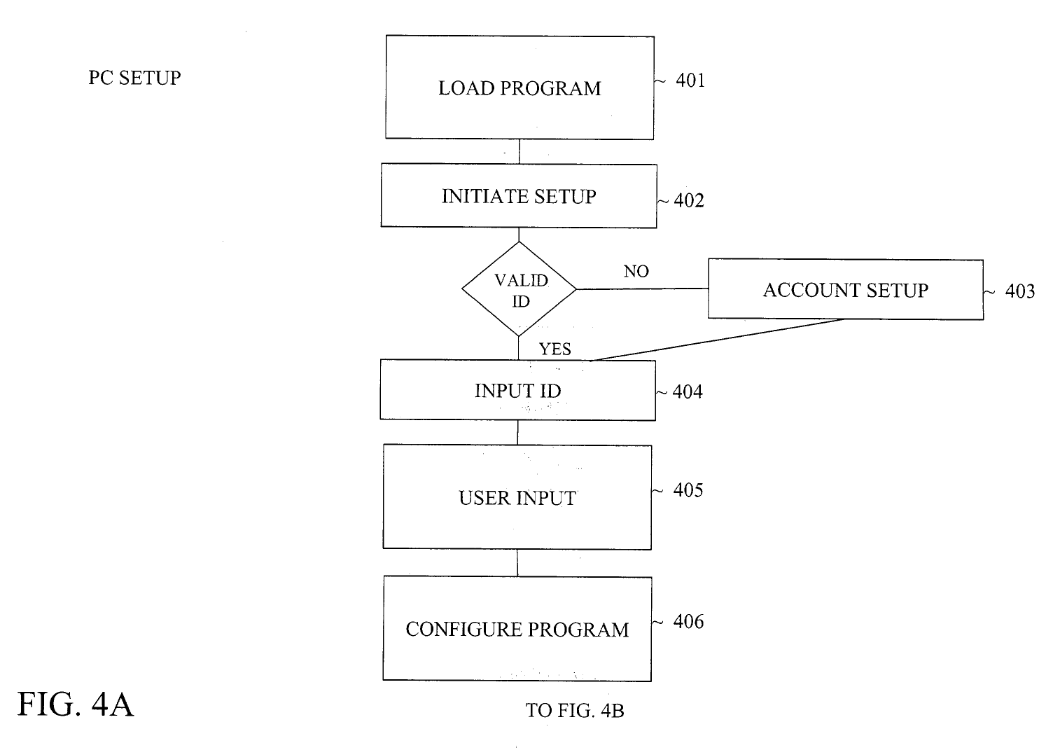

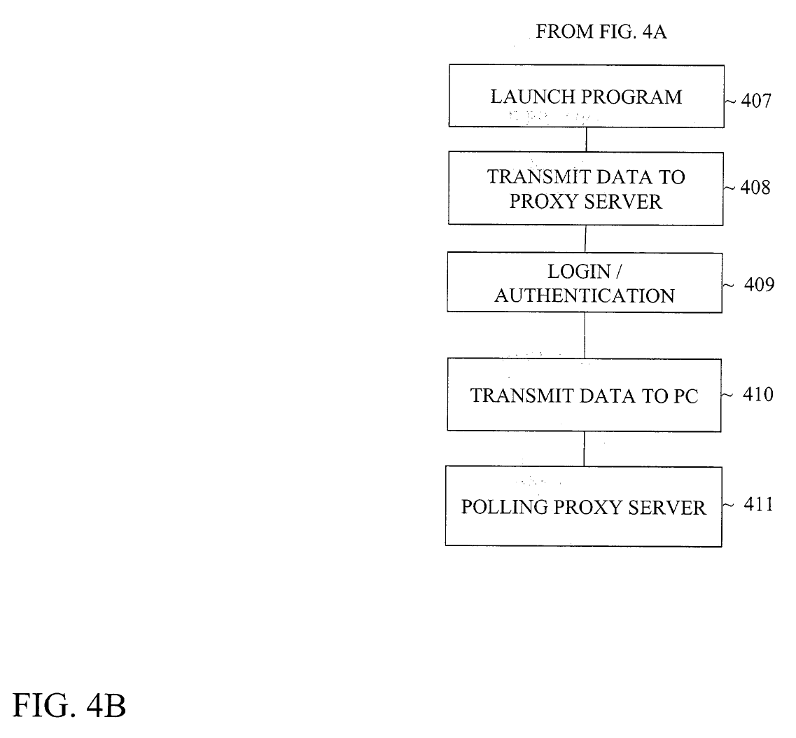

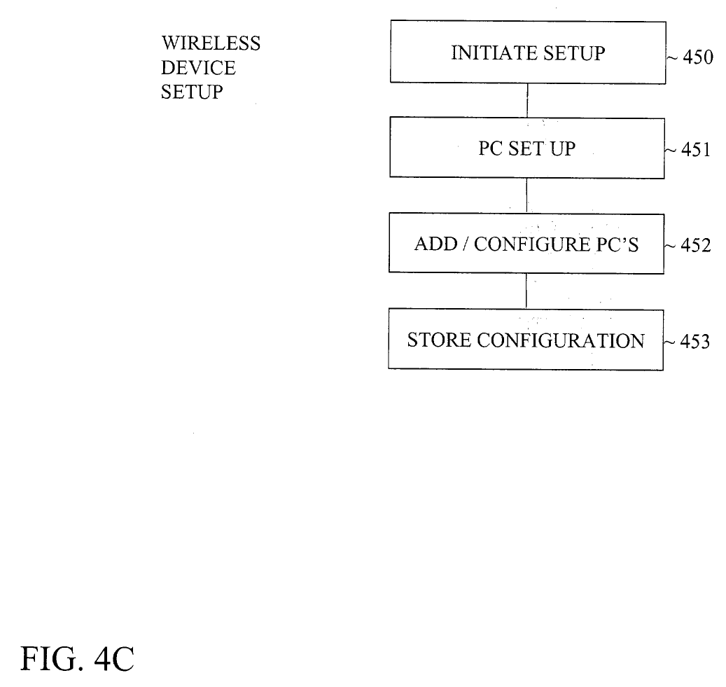

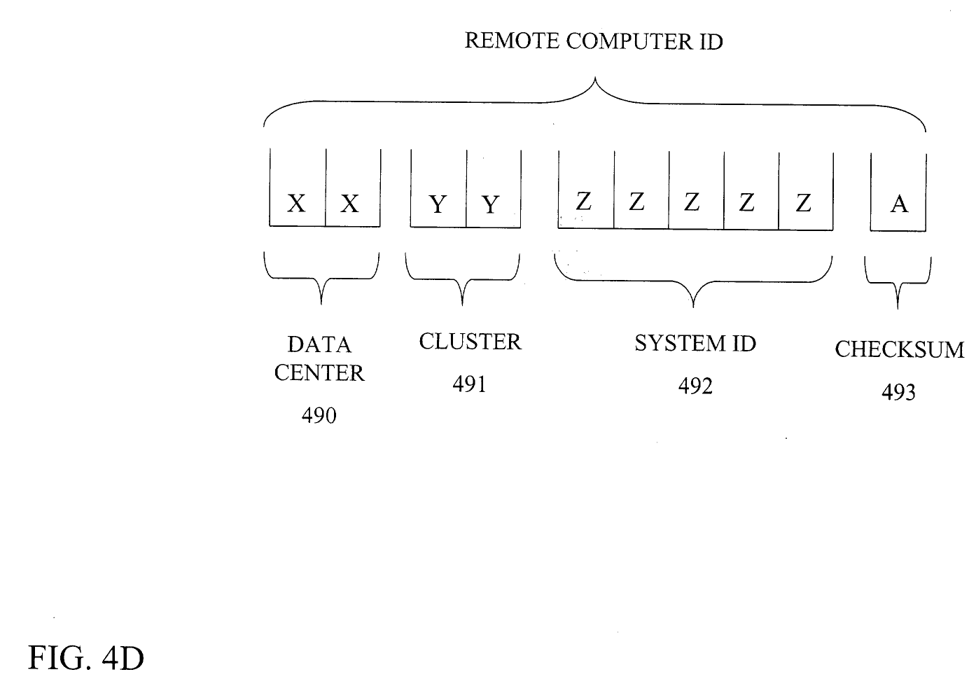

FIG. 4A is a flow diagram illustrating a preferred embodiment for establishing a user account and installing an instance of program 304 on PC 102. As shown in FIG. 4A, at step 401, an instance of program 304 is loaded on PC 102. In step 402, an initial setup screen is presented to the user. In one preferred embodiment, the user initiates PC setup by navigating to a suitable Web page using a browser on a PC 102 and downloading the program. Alternatively, software for performing PC setup may be provided on a storage medium, such as a compact or floppy disk suitable for reading by an input/output device of a PC 102.

A user interface provided by the setup environment preferably queries the user for a valid remote computer ID (RID). If the user does not yet have a valid RID for PC 102, he or she is preferably directed to a registration screen. Otherwise, processing proceeds directly to step 404, described below.

At the registration screen, the user is preferably required to input appropriate information including billing, payment, and registration information (step 403). Billing information preferably may include the name, address, and phone number of the user or corporate entity. Payment information preferably may include credit card information, debit card information, or invoicing information. Registration information preferably includes a user name, password for account access, e-mail address, and any other pertinent user information. Since each RID corresponds to one PC 102, the user may repeat this step for each PC for which the user wishes to establish a RID.

In some preferred embodiments, particularly those in which an enterprise solution of the present system is implemented, a single corporate account may be setup and the enterprise authorized to issue some specified number of RIDs. User employees of the enterprise may then be assigned a RID by the enterprise system administrator.

In step 404, the user inputs a valid RID corresponding to a particular PC 102. As shown in FIG. 4D, the RID preferably comprises a plurality of fields including a field designated to identify a routing data center 490, a field to identify a computing cluster within the data center 491, a field to identify PC 102 within the cluster 492, and a check sum field 493. As will be recognized, in the particular exemplary embodiment of FIG. 4D, the system may include up to 100 proxy server clusters in a data center and up to 100 data centers. Proxy server clusters may contain any desired number of proxy servers. Each proxy server may handle connections between a plurality of pairs of communicating devices.

In step 405, the user is prompted to input a password that uniquely identifies the user for login purposes and will be required for accessing PC 102 from wireless device 100.

Program 304 is preferably configured in step 406 using the management component 394. During configuration, the user may be prompted to select manual or automatic setup. If the user selects manual setup, all information fields must be input manually. These may include, for example, outgoing mail server settings, reply e-mail address, and any necessary network settings. If the user selects automatic setup, configuration settings are automatically retrieved to the extent possible from the PC registry, user address book, network settings, etc.

After a successful configuration, the application is launched in step 407. Thereafter, the program is preferably automatically launched whenever PC 102 is booted up, as described above.

Once launched, program 304 preferably establishes an HTTP connection with proxy server 104 and sends encrypted authentication information to the proxy server (step 408). The authentication information may include the RID of PC 102. Proxy server 104 receives the encrypted information and authenticates the login request using one of a plurality of well-known authentication systems (step 409). After a successful login, proxy server 104 returns a cookie and other information to PC 102 (step 410). This cookie is used by PC 102 to poll the proxy server periodically, so that PC 102 may receive information from proxy server 104 in the form of a response to a polling request (step 411). Proxy server 104 accepts polling requests from PC 102 until the cookie becomes invalid, at which time PC 102 must again log in with proxy server 104. When proxy server 104 returns the cookie, upon successful login by PC 102, it may also return a list of DNS domain names that PC 102 may use when polling the proxy server and a maximum polling response period permitted by the proxy server 104. Each DNS domain name entry preferably allows PC 102 to derive a DNS host name that resolves to the same IP address i.e., the address for the proxy server assigned to handle communications between PC 102 and wireless device 100. This aspect of DNS host name derivation is described in detail below. For each polling proxy server request, PC 102 randomly selects one of the DNS domain names from which it derives the DNS host name. In this way no pattern of accessing a particular DNS host name or domain can be detected.

FIG. 4C is a flow diagram illustrating a preferred embodiment for installing an instance of program 320 on wireless device 100. As shown in FIG. 4C, at step 450, the user initiates wireless device setup. In one preferred embodiment, the user initiates setup by navigating to an appropriate Web page using a browser on wireless device 100. The Web page may provide a link which when selected causes an instance of program 320 to be download to wireless device 100. In another preferred embodiment, a copy of the program may be provided to the user on a suitable storage medium and the program may be loaded from the medium via a data cable connected to the wireless device. In yet another preferred embodiment, a copy of the program may be provided to the user via other proprietary download mechanisms operated by the wireless provider, e.g. a provisioning system or software distribution system. In yet another preferred embodiment, the program is preloaded onto wireless device 100 before purchase by the user.

In step 451, the user is prompted with a PC setup screen. In step 452, the user preferably inputs a name by which the user wishes to refer to a PC 102 and the PC's corresponding remote computer ID (RID) for each computer the user wishes to access from the wireless device. In step 453, wireless device 100 stores this name/RID pair in memory. As described below, when a user wishes to access a remote computer, a menu of stored computer names is displayed to the user. Selection of a computer on the menu causes wireless device 100 to retrieve the computer's RID. Accordingly, the user need not remember the RID for a PC 102 to access it remotely from wireless device 100.

System Operation

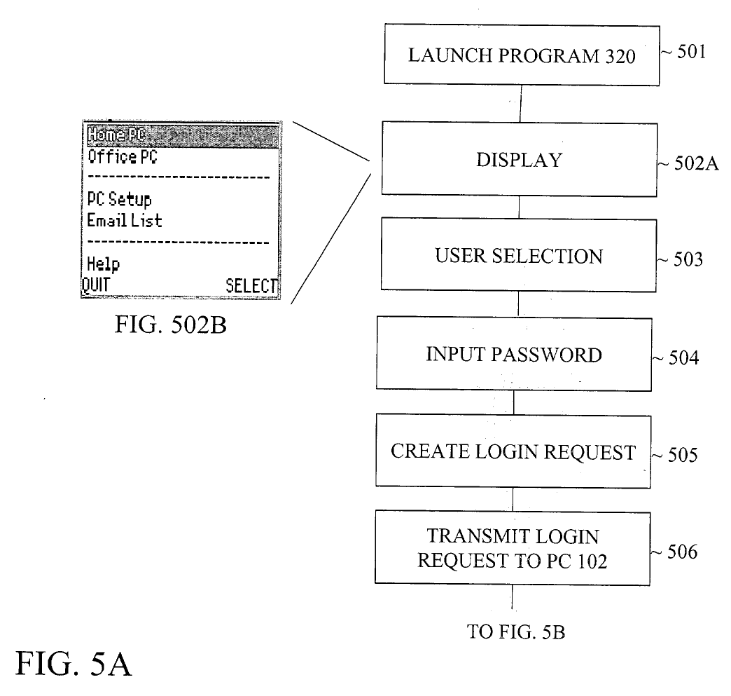

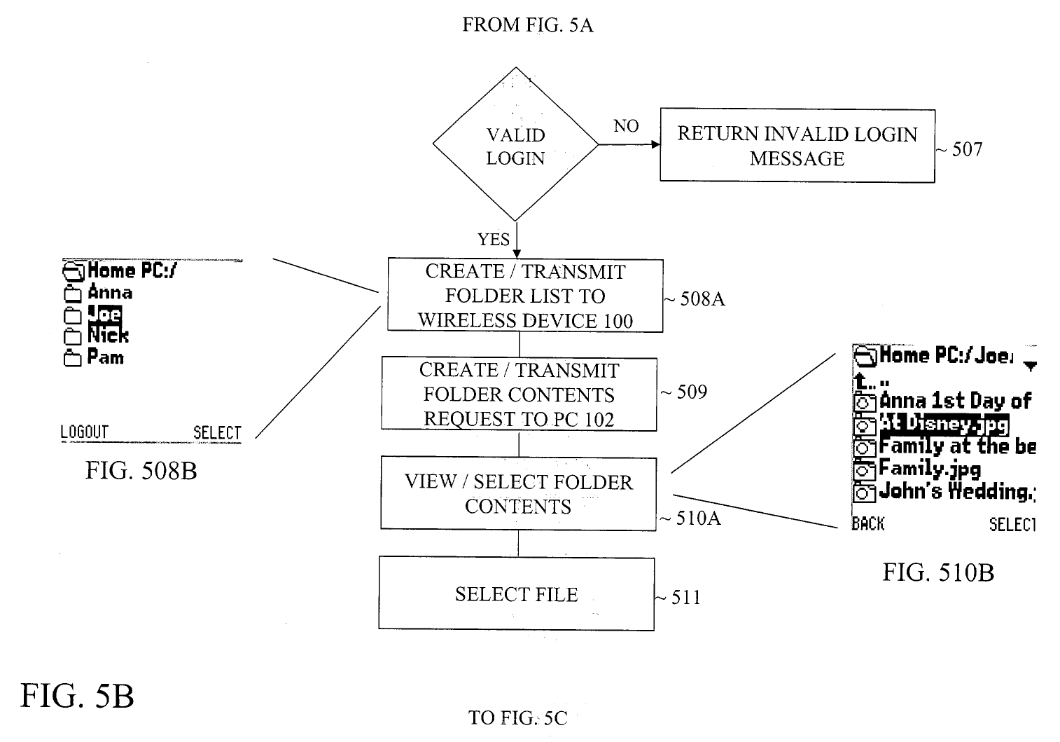

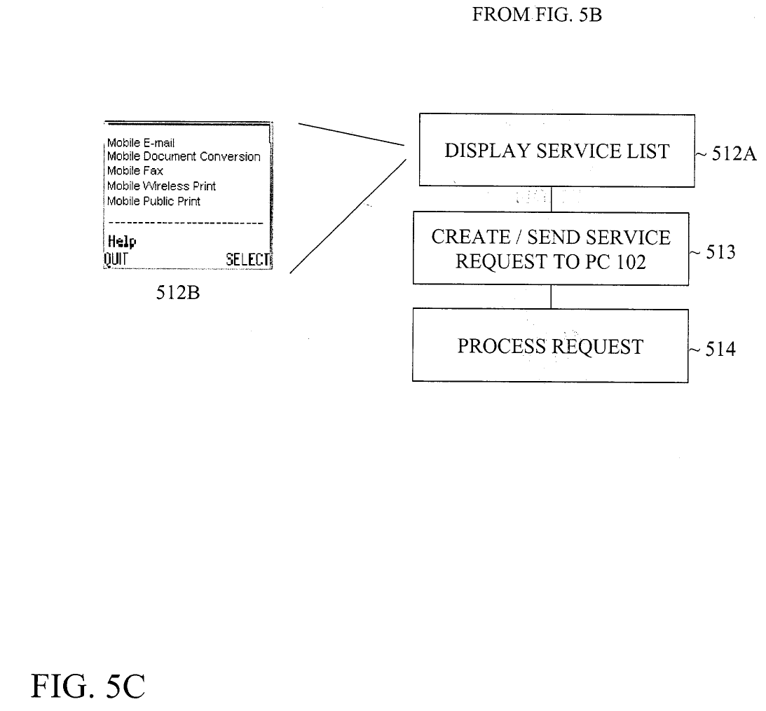

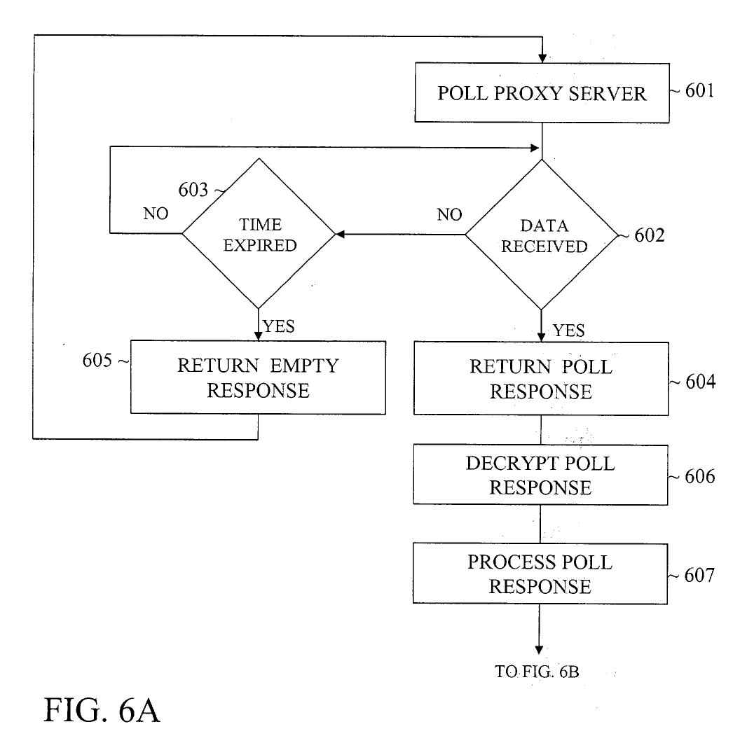

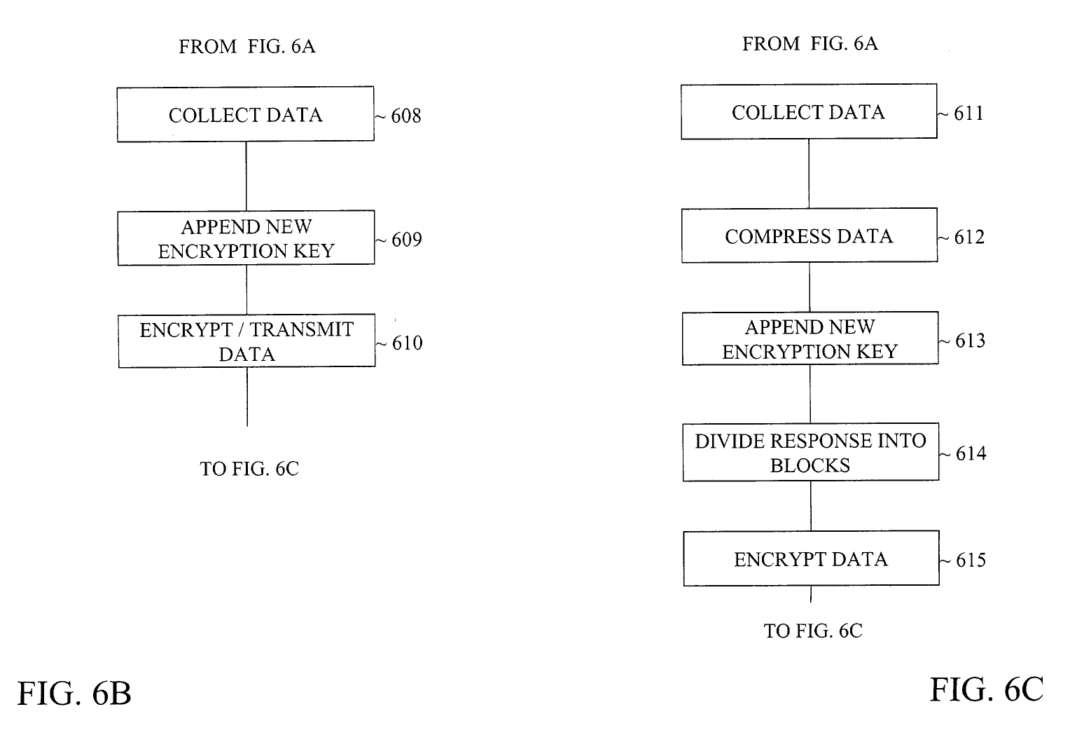

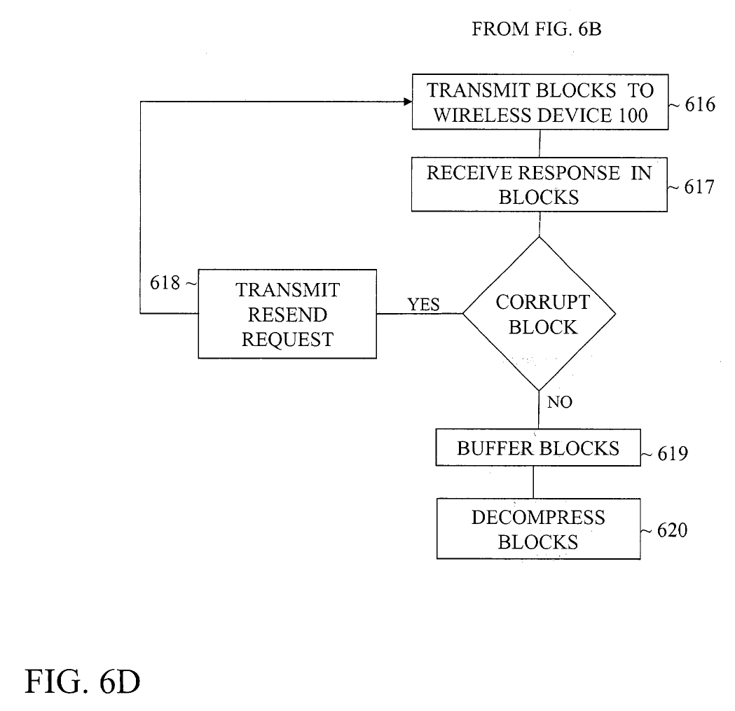

Before describing the operation of particular system services in detail, an overview of system operation, and the user experience associated therewith, is first presented in connection with FIGS. 5-6. Beginning with FIG. 5, in step 501, when a user wishes to access, for example, files or other resources stored on or otherwise available to a remote PC 102, he or she launches program 320 on wireless device 100. In a preferred embodiment, program 320 may be launched by selecting the program from a menu of available applications stored on wireless device 100.

In step 502A, each PC 102 for which the user has previously entered a RID is displayed on a menu screen of wireless device 100. One exemplary embodiment of such a menu screen is shown in FIG. 502B. As further shown in FIG. 502B, the menu screen may also include a PC Setup selection to allow the user to store, edit, modify or delete RIDs for additional computers the user may wish to access remotely.

In step 503, the user selects one PC from the menu (e.g., home PC 102A or work PC 102B). Alternatively, the user may be prompted to select a PC by entering the PCs RID directly. In step 504, the user is prompted to enter the appropriate password for the selected PC 102. In a preferred embodiment, to ensure security, the password is not stored on wireless device 100, and is stored only on PC 102 for user authentication and authorization purposes.

In step 505, program 320 constructs a login request for the selected PC 102 and transmits it to PC 102 via proxy server 104. In a preferred embodiment, the login request (and subsequent messages) transmitted by wireless device 100 to proxy server 104 is included in an HTTP request to proxy server 104. In some preferred embodiments, the login request may include one or more parameters associated with wireless device 100. These parameters may preferably include information such as the amount of memory available on wireless device 100. As described in more detail below, in a preferred embodiment, data transmitted by PC 102 to wireless device 100 is transmitted in blocks of suitable size for the wireless device. This suitable size is preferably determined as a function of the wireless device parameter values specified in the login request.

In a preferred embodiment, routing data center 490 and computing cluster 491 in the RID of PC 102 are used as parameters to derive the DNS host name of the proxy server contacted by wireless device 100. A third parameter used to create the DNS entry may be based on PC 102's region, the user's wireless carrier, or other business parameters. A fourth parameter used may be a DNS host name specified by the entity that operates proxy server 104. For example, assume that PC 102 is assigned a RID of 1011123458 (i.e., a routing data center “10”, a cluster “11” and a system ID “12345”). Assume further that PC 102 is assigned a region “01” (possibly signifying the mid-west region), and that the specified DNS domain name is “service-provider.com”. In this example, the derived DNS host name used in the HTTP communication by the wireless device is: http://d10.c11.r01.service-provider.com/. The proxy server corresponding to this DNS entry parses the request with the appropriate system ID 492 and manages communications between wireless device 100 and PC 102.

In a preferred embodiment, the login request and the subsequent messages described below are transmitted to PC 102 (step 506) and received by wireless device 100 via an HTTP connection established with proxy server 104. In a preferred embodiment, wireless device 100 derives the DNS entry for proxy server 104 from the RID for PC 102. When proxy server 104 receives the login request or subsequent message, it preferably identifies the target PC 102 by its RID included in the message and forwards the message to the target PC 102. This preferred embodiment for establishing communication between wireless device 100 and PC 102 via proxy server 104 is described in more detail below. In a preferred embodiment, the content of the login request from wireless device 100, and each subsequent message exchanged between wireless device 100 and PC 102, is encrypted so that it cannot be read by proxy server 104 or other entities, as described below.

PC 102 preferably authenticates the login request to determine whether or not it is valid. A preferred embodiment for authenticating the login request is described below. If the login request is not valid, PC 102 returns an “invalid password or security failure” message to proxy server 104 which is forwarded to wireless device 100 for display to the user (step 507).

Otherwise, in step 508A, PC 102 creates a default list that identifies folders stored on PC 102, or other resources accessible by PC 102, that may be accessed remotely from wireless device 100. PC 102 transmits this list to wireless device 100 via proxy server 104 for display to the user. An exemplary embodiment illustrating display of a default folder list is shown in FIG. 508B.

In a preferred embodiment, the parameters of the default folder list are preferably determined during user account setup. For example, the default folder may be set to some directory on the C drive of PC 102 such as “c:/my documents” or a specially created directory such as “c:/downloads”. Alternatively, PC 102 may collect data for the default folder list based on the login request.

Using the wireless device interface, the user may select a folder from the list. This causes wireless device 100 to create a folder contents request and transmit the request to PC 102 via proxy server 104 (step 509).

In step 510A, PC 102 processes the request by obtaining information regarding the contents of the selected folder and transmitting this information to wireless device 1100 via proxy server 104 for display to the user. An exemplary embodiment for displaying this information is shown in FIG. 510B. This folder listing information may include information relating to the names of other folders present in the selected folder, the names of files present in the folder the types of files present in the folder, and any associated icons for the files or folders present in the selected folder. In a preferred embodiment, PC 102 also transmits with this folder information a list of services available for each file. For example, for each text file, PC 102 may preferably transmit a list of services that apply to the document, such as: e-mail, convert, fax, print to public printer, etc. By contrast, for a .dll file, PC 102 may transmit a list of services that includes only the e-mail service.

The user may then select either a folder or file from the displayed list. If a folder is selected, wireless device 100 creates another folder-contents request and the steps described above are repeated. By contrast, if the user selects a file (step 511), wireless device 100 displays the list of services available for the selected file to the user (step 512A). An exemplary embodiment for displaying this list to the user is shown in FIG. 512B.

In a preferred embodiment, the file, folder and service information may preferably be sent in un-blocked form to increase system speed and efficiency, as described below. Additionally, such data may be cached on wireless device 100, if desired, to avoid the need to resend the data to satisfy a subsequent request.

Using the wireless device interface, the user may then select a particular service. When the user selects a service, wireless device 100 generates an appropriate service request and transmits it to PC 102 via proxy server 104 (step 513). In step 514, PC 102 initiates fulfillment of the requested service. Preferred embodiments for providing a variety of system services are described in detail below. It should also be noted that although, for ease of illustration, the initial default data transmitted to wireless device 100 was described above as a default folder list, such data could also include directly selectable files and other accessible resources, if desired.

In a preferred embodiment for authenticating a login request from wireless device 100, data keyed in by the user to wireless device 100 and otherwise known only to PC 102 is processed using a one way function to derive an encryption key. This encryption key is used to encrypt the login request. In a preferred embodiment, the data used to generate the encryption key may, for example, include some or all of the password and some or all of the RID associated with the PC to be accessed: Using the same one-way function, PC 102 also derives the same key and uses it to decrypt the login request. A received login request is deemed authenticated if the decrypted request is properly formatted and satisfies certain requirements. For example, a login request may be deemed authenticated if it includes a valid command at a designated location in the message string. Since the data from which the encryption key is derived is known only to PC 102 the encryption key cannot be derived by others (including, for example, proxy server 104) even if such entities learn the one-way function.

As will be recognized, wireless carrier 112 will, in many cases establish a maximum idle connection time for the HTTP connection between wireless device 100 and proxy server 104 before the connection is closed. In a preferred embodiment, when an HTTP message is received from wireless device 100, proxy server 104 returns any data requested by wireless device 100 in an HTTP response before this period expires.

In addition, when it appears that data requested by wireless device 100 will not be ready for transmission before the wireless device's connection will close, an interim message indicating this fact may be transmitted to wireless device 100 by or via proxy server 104. In some preferred embodiments, this message may include information regarding the estimated time until the requested data will be ready for transmission. Wireless device 100 may then determine whether or not to transmit a second HTTP request for the requested data at a subsequent time such as at approximately the estimated time.

FIG. 6 is a flow diagram illustrating a preferred embodiment for establishing bi-directional communication between PC 102 and wireless device 100 via proxy server 104 in the present system and method. In a preferred embodiment, PC 102 may be unable to accept incoming packets, and is therefore preferably enabled to receive information in the form of a response to a polling request. More specifically, as shown in FIG. 6, in step 601, PC 102 periodically polls proxy server 104.

In a preferred embodiment, routing data center 490 and computing cluster 491 in the RID of PC 102 are used as parameters in creating the DNS entry polled by PC 102. A third parameter used to create the DNS entry may be based on the user's region, the user's wireless carrier, or other business parameters. A fourth parameter used may be selected randomly from one or more DNS domain names included with a cookie provided by proxy server 104, as described in detail below. For example, assume that PC 102 is assigned a RID of 1011123458 (i.e., a routing data center “10”, a cluster “11” and a system ID “12345”). Assume further that PC102 is assigned a region “01” (possibly signifying the mid-west region), and a DNS domain name “random.com”. In a preferred embodiment, the DNS derived host name used in the HTTP address polled by PC102 is: http://d10.c11.r01.random.com?=cmd=SYSTEMID=12345. As described in detail below, the derived DNS host name will resolve to an IP address corresponding to a particular proxy server.

The polling request from PC 102 preferably includes a plurality of data fields including a time period to wait before replying to the polling request with an empty data response, as described below.

If proxy server 104 has received data for PC 102 since the previous polling period (step 602), a poll response including the data is immediately returned to PC 102 in step 604, as described in more detail below. Otherwise, proxy server delays responding to the polling request for a period up to the time period specified in the polling request (step 603). If data from wireless device 100 is received before the time expires (loop 602-603), this data is immediately returned to PC 102 in step 604, as described below. Otherwise, an empty response is transmitted to PC 102 (step 605).

In a preferred embodiment, the specified time period before an empty response is returned may be dynamically determined by PC 102 to maximize the time between polling request and empty responses. This enables proxy server 104 to reduce overhead and thus maintain the largest number of connections.

More specifically, PC 102 preferably is adapted to determine the maximum connection time allowed between proxy server 104 and PC 102 without a polling response, i.e., the maximum idle connection time allowed by, for example, firewall 114 before it closes the network connection between PC 102 and proxy server 104, due to inactivity. PC 102 preferably specifies this time as the time period proxy server 104 should wait before returning an empty response, as described above.

In one preferred embodiment for determining this time period, a polling response time period may be specified as 45 seconds and included by PC 102 in its first polling request. If the connection between proxy server 104 and PC 102 is not terminated during this 45 second idle interval, PC 102 may increase the polling response period by some amount (e.g., 15 seconds) in its next message. If the connection is not terminated with this increased time frame, the polling response period is again increased. These steps are repeated until the connection is closed by an intermediary party (e.g., firewall 114) managing or monitoring connections between PC 102 and proxy server 104, or the polling response period exceeds a maximum polling response period that may be included by the proxy server 104 in the transmission of step 410. When such connection is closed, PC 102 decreases the polling response period to a lower time period, such that the connection is not closed by an intermediary party, or it does not exceed the maximum polling response period sent from proxy server 104.

In the event that the default time period specified in PC 102's first polling requests causes the connection to be closed by an intermediary party managing or monitoring connections between PC 102 and proxy server 104, or it exceeds the maximum polling response period sent from proxy server 104, the steps above may be reversed, and the time frame decreased until a time period that is lower than the proxy server's maximum allowable polling response period or does not cause a connection closure is identified.

Returning to FIG. 6, in step 604, when data is received from wireless device 100 at proxy server 104, it is included in a polling response to PC 102.

As noted above, each message transmitted by wireless device 100 is preferably encrypted. More specifically, in a preferred embodiment, the first message transmitted by wireless device to establish a communication with PC 102 (i.e., the login message) is preferably encrypted using a key known to or that can be determined by PC 102. This initial key preferably may be derived from information keyed in by the user. Subsequent messages are encrypted using a cryptographic key included by PC 102 with responsive messages that it transmits back to wireless device 100, as described in more detail below.

Accordingly, in step 606, PC 102 decrypts the enclosed data transmission from wireless device 100. In step 607, PC 102 processes the received data to determine its message type. The received data may, for example, represent a login request, a data request (i.e., a folder contents request or available-services request), or a service request. In the presently preferred embodiments, most login and data requests require PC 102 to respond with data to wireless device 100 via proxy server 104. For example, in response to a valid login request, PC 102 transmits folder list data to wireless device 100 for display to the user. In addition, as described below, certain service requests may also require transmission of data from PC 102 to wireless device 100 via proxy server 104. A preferred embodiment for transmitting data from PC 102 to wireless device 100 via proxy server 104 is now described.

In a preferred embodiment, the present system and method are adapted to transmit data to wireless device 100 in a manner that maximizes speed and efficiency and thus enhances the user experience. More specifically, when the quantity of data to be transmitted is relatively small, the overhead associated with compressing the data for transmission may outweigh any benefits in transmission speed. Moreover, it may be unnecessary to divide small amounts of data into blocks to accommodate memory size limitations of the wireless device. This will typically be the case in transmitting folder, file, and service list information from PC 102 to wireless device 100 unless the quantity of such information is unusually large. Accordingly, in a preferred embodiment, such data is simply encrypted by PC 102 and transmitted uncompressed to wireless device 100 via proxy server 104 as a single block, as described below.

By contrast, when the quantity of data to be transmitted is relatively large, it may be significantly more efficient to compress the data before transmission. Moreover, the amount of data may exceed the memory capacity of wireless device 100. This will typically be the case when a print file is streamed from PC 102 to wireless device 100, as described below. Accordingly, in a preferred embodiment, when large quantities of data are to be transmitted via proxy server 104 to wireless device 100, the data is first compressed and divided into blocks. Preferred embodiments for each of these transmission paradigms are now described in connection with FIGS. 6B-6D. One of ordinary skill may determine whether a particular volume of data warrants compression and/or dividing into blocks as a function of a number of parameters which may include the particular compression technology used and characteristics of the network connection and wireless device. It should also be noted that although both compression and dividing the data into blocks are implemented in the preferred embodiment described below, one or the other of these techniques may be used individually in alternative embodiments.

A preferred embodiment for transmitting small data quantities is now described in connection with FIG. 6B. As shown in FIG. 6B, in step 608, PC 102 collects any data to be transmitted to wireless device 100. In step 609, a new encryption key is appended to the data. As noted above, wireless device 100 will preferably use this new key to encrypt its next message to PC 104. Accordingly, in this preferred embodiment (and the one described below in connection with FIG. 6C), a unique key is used for each pair of messages between PC 102 and wireless device 100, i.e., for each send and reply pair. By allocating the task of key generation to PC 102, the present system and method are able to leverage the relatively large computing power of PC 102 as compared to that of wireless device 100, thus improving system performance. In step 610, the complete message is encrypted before and then transmitted from PC 102 to proxy server 104 for routing to wireless device 100.

A preferred embodiment for transmitting larger data quantities is described in connection with FIGS. 6C-6D. In particular, in step 611, PC 102 collects any data to be transmitted to wireless device 100.

In step 612, the data is compressed. In a preferred embodiment, PC 102 compresses data using a compression algorithm such as “Byte Pair Encoding” which requires more computing power to compress than to decompress data. This again makes it possible to leverage the relatively large computing power of PC 102, enable faster data transfer, and optimize the user experience. In step 613, a new encryption key for the next message pair is appended to the compressed data.

As noted above, wireless device 100 preferably includes certain parameters such as memory capacity in the login request transmitted to PC 102. In a preferred embodiment PC 102 preferably determines an optimal block size for transmitting data to wireless device 100 based on the parameters received from wireless device 100. In another preferred embodiment, PC 102 may determine the optimal block size based on other factors, such as network limitations or PC capabilities. In yet another preferred embodiment, the block size is specified by wireless device 100.

If the amount of data to be transmitted exceeds the optimal block size, PC 102 divides the compressed data into blocks of that size in step 614. In step 615 the complete message is encrypted before transmission. In step 615, PC 102 begins to transmit blocks of data to wireless device 100 via proxy server 104.

In a preferred embodiment, wireless device 100 controls the flow of blocks by requesting additional blocks from PC 102 as they are needed. In this way, wireless device 100 can suspend one data transfer to accept another data transfer, or to accept a digital or analog connection. For example, if wireless device 100 is a cellular phone, it may pause the transmission from PC 102 to accept an incoming call. When the call is completed, wireless device 100 may re-initiate block transmission by requesting the next block in the sequence.

When more than one block is to be transmitted, the blocks are preferably transmitted one at a time to proxy server 104 via HTTP connection 301 and forwarded from the proxy server to wireless device 100 via HTTP connection 300 (step 616). The first block transmitted from PC 102 to wireless device 100 preferably contains information regarding the data volume, such as total number of blocks, total data file size, and total number of pages.

Wireless device 100 receives the message and decrypts it using the same key used to send the request that triggered the message (step 617). If wireless device 100 determines that a block is corrupt, it requests that the block be resent in step 618.

After a valid block is received and decrypted, it is placed in a buffer in step 619. The implementation of the buffer is described in more detail below. The buffered blocks are then decompressed in step 620. In one preferred embodiment, if the request was for a file or folder listing, wireless device 100 determines if enough blocks have been received to update the display screen. If more blocks are needed, wireless device 100 returns to step 610 to await additional blocks. If enough blocks have been received, the reconstructed response is displayed on the device screen for further user action.

In a preferred embodiment, different block sizes may be selected to transmit different types of messages to wireless device 100. For example, it may be determined that the preferred block size for transmitting a print file to wireless device 100 is 2 KB, while the preferred block size for transmitting other data, such as folder, file, or service information, may be 8 KB. Thus, with respect to this information, the system may avoid overhead associated with dividing the data into blocks for data volumes only slightly in excess of 2 KB, while retaining the capability to divide such data into blocks when the data volume is more significant.

As noted above, each new data transmission is encrypted with the latest encryption key from PC 102, and each new response from PC 102 has embedded in it a new encryption key. Accordingly, each transmission pair, i.e., send and receive message pair, are encrypted using a unique encryption key.

System Services

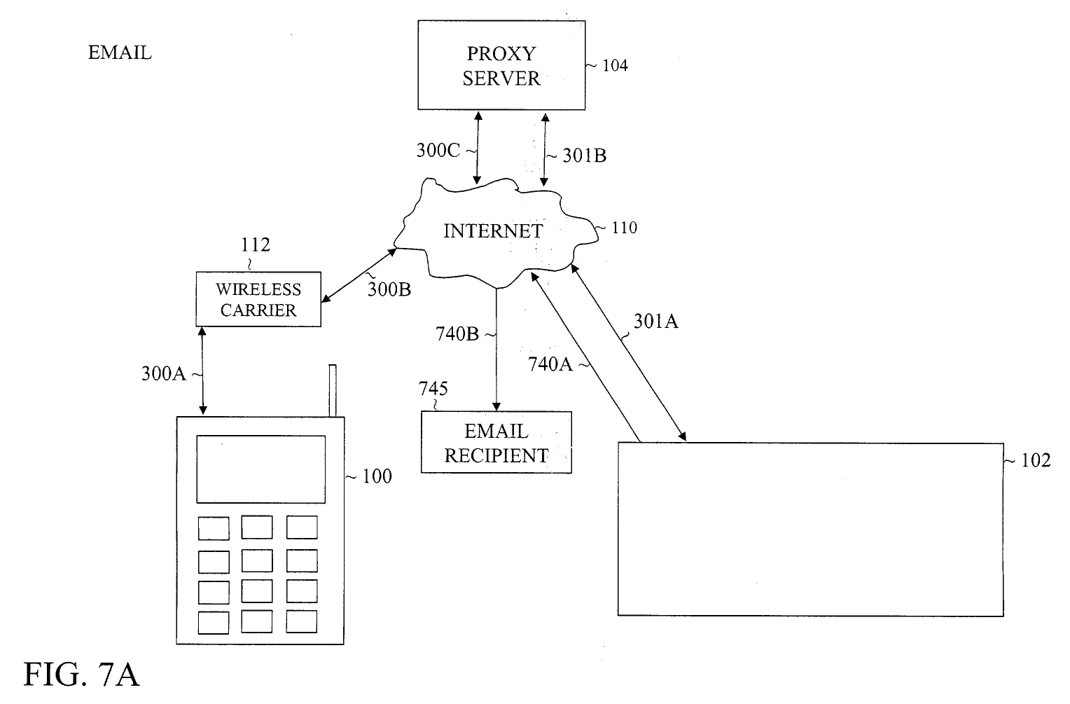

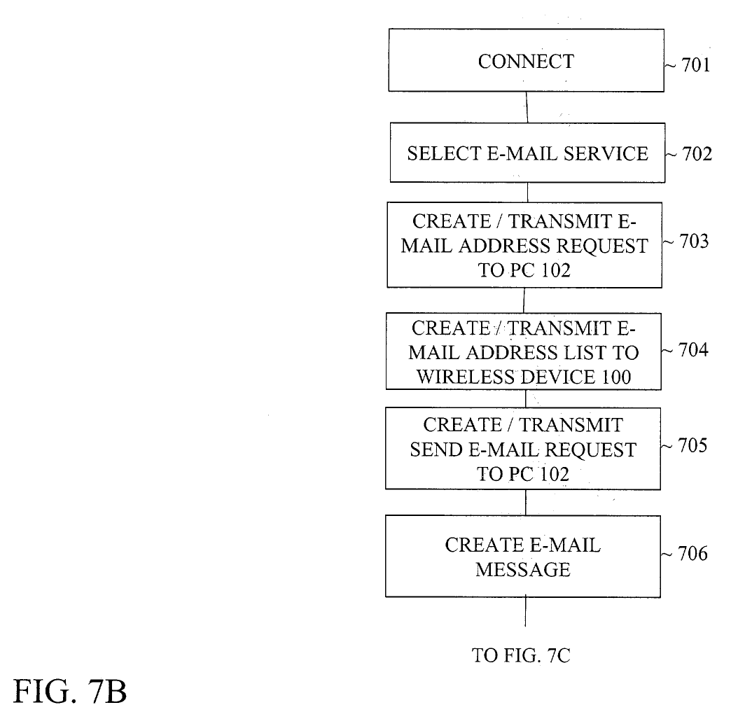

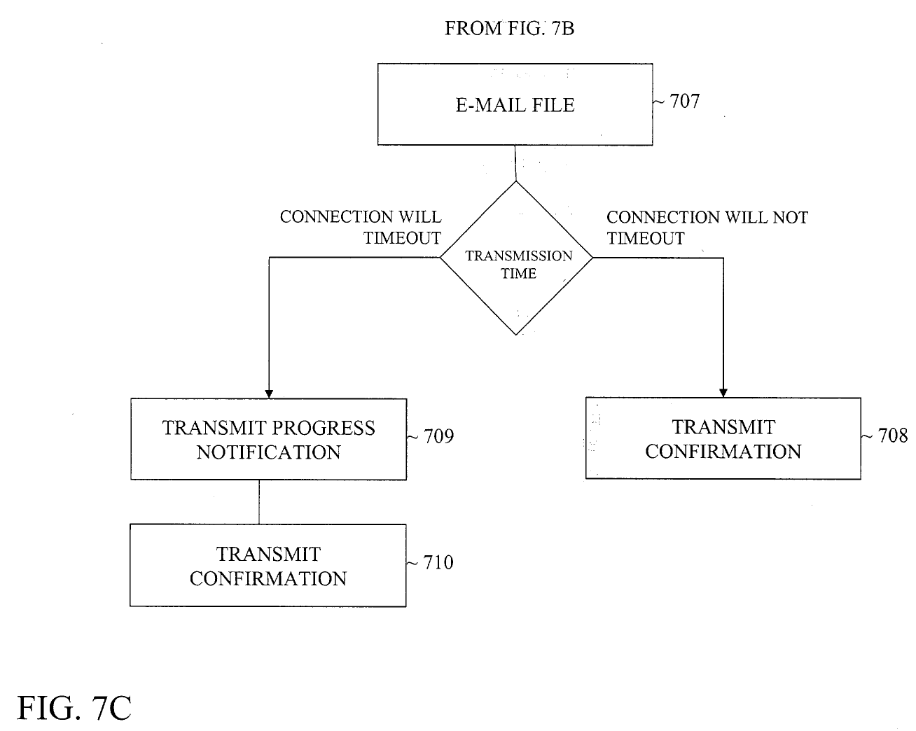

As noted above, the present system and method are preferably adapted to provide users with access to a variety of services via wireless device 100. One such service permits a user to e-mail a file on a remote PC 102 to any e-mail address. A preferred embodiment for implementing this service is described in connection with FIGS. 7A-7C. Components in FIG. 7A that correspond to those described in connection with FIG. 3 above are designated with corresponding reference numerals.

Operation of the system shown in FIG. 7A will now be described in connection with FIGS. 7B-7C. In step 701, the user logs on to PC 102 from wireless device 100 via HTTP connections 300 and 301. After a successful login, PC 102 returns the default folder list to wireless device 100.

As described above, if the user selects to view folder contents, PC 102 replies with the contents of the selected folder. Additionally, if the user selects to view services available for a particular file, PC 102 replies with a list of available services for the file. From this list, the user may select to electronically mail the file to an e-mail recipient as an attachment (step 702). Wireless device 100 then preferably generates a request for e-mail address information and related data and sends it to PC 102 via proxy server 104 (step 703).

PC 102 responds to the request by generating a list of potential e-mail recipients and sending it to the wireless device for display to the user (step 704). This list may contain the name, e-mail identification, URL, or other pertinent information of e-mail recipients.

Using the wireless device interface, the user may scroll through the e-mail address list and select a specific e-mail address. In another preferred embodiment, the user may input an e-mail address rather than sending a request for e-mail address information. In yet another preferred embodiment the user may access one or more e-mail addresses stored on wireless device 100. In yet another preferred embodiment, the user may download e-mail information accessible by PC 102, or may query a database for specific e-mail addresses.

In step 705, wireless device generates a message that includes the selected or input e-mail address and sends it to PC 102 via the proxy server. The message may also include a request by the user to include information in the subject line of the e-mail and may also include a request to include a message in the body of the e-mail itself.

In step 706, PC 102 creates an e-mail to send to the selected e-mail address including any user specified text, and attaches the selected file to the e-mail message. PC 102 then transmits the e-mail message with attachment to the designated recipient 745 via connection 740 (step 707).

In a preferred embodiment, the system is adapted to determine when a service is not likely to be completed before the connection between wireless device 100 and proxy server 104 is dropped. If the service is likely to be completed in time, PC 102 sends a confirmation via the established HTTP connection when the service is complete (step 708). If not, PC 102 transmits an “in progress” message to wireless device 100 using the established HTTP connection (step 709). Subsequently, when the service is complete, PC 102 sends a confirmation message to wireless device 100 via a Short Messaging System (“SMS”), or other text based messaging system (step 710).

For example, assume that a request to e-mail a 3 MB attachment is received from a wireless device that connects to proxy server 104 via a connection that times out after 30 seconds. If, for example, PC 102 is connected to its e-mail server via a 56K dialup connection, it would determine that the time required to transmit the 3 MB file would exceed 30 seconds. Consequently, in this case, the system is preferably adapted to immediately send an “in progress” notification to wireless device 100 via the established HTTP connection. When the transmission is complete, PC 102 then sends a confirmation message via SMS or other text based means, as described above. By contrast, if the PC 102 is connected to its e-mail server via a 100 Mbps network connection, PC 102 would determine that the transmission will not take longer than the 30 second timeout limit. Accordingly, it would wait for completion of the e-mail and then send a confirmation to wireless device 100 via the established HTTP connection.

The status notification or confirmation message may contain information regarding the time and date of the transmission, the recipient e-mail address, the size of the e-mail transmitted, and a copy of the subject line and/or body text.

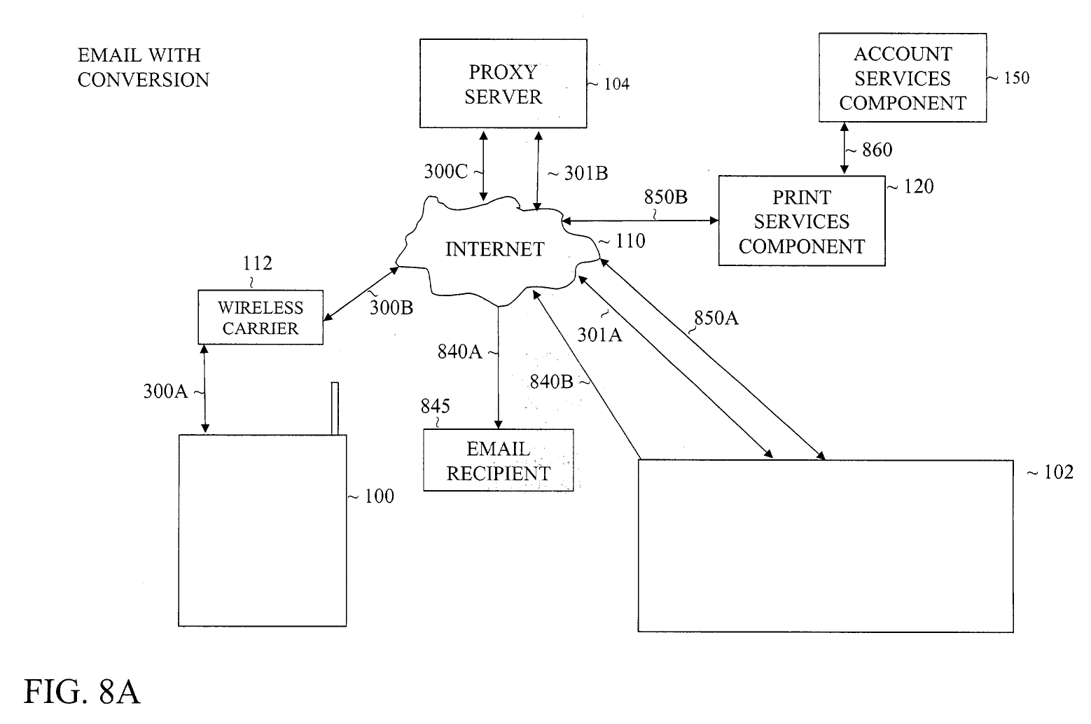

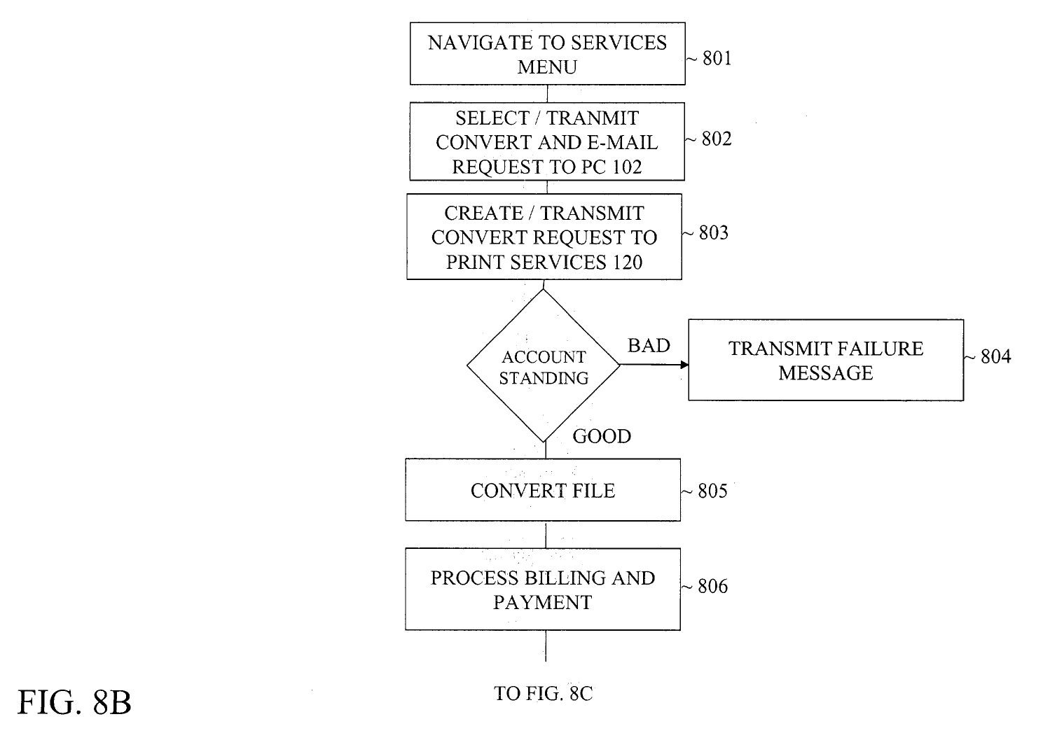

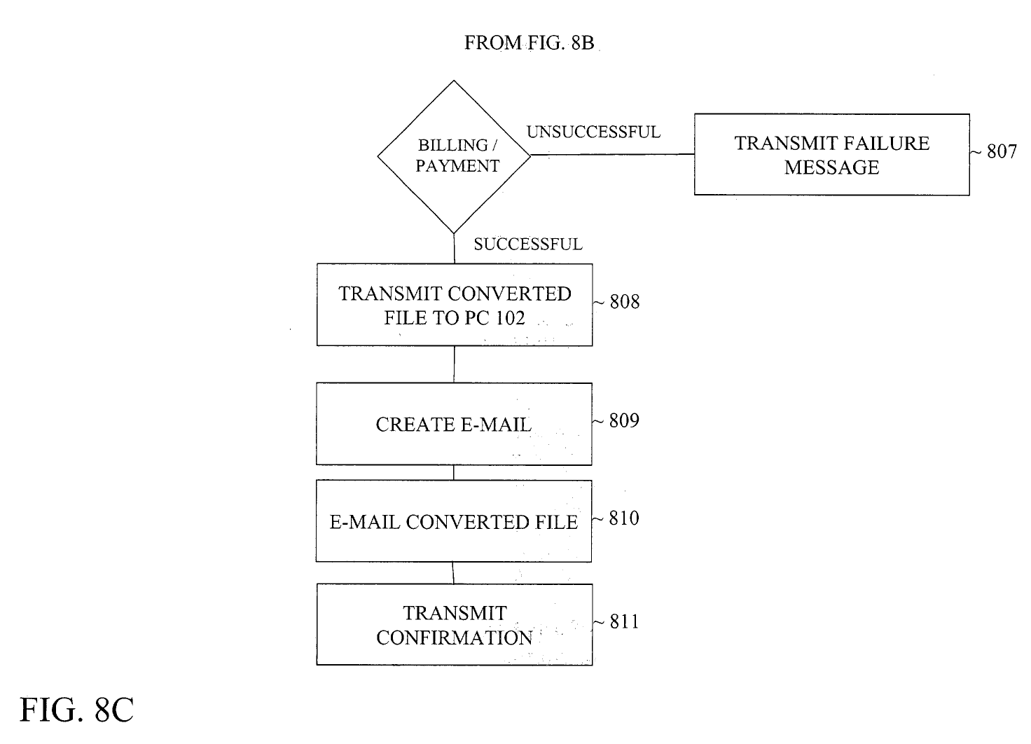

In another preferred embodiment, the e-mail service described above may be augmented with an additional feature that allows a user to convert the file to a different format before transmission of the e-mail. For example the user may select to convert a Word® file into Adobe Acrobat® format, Wordperfect® format, or from a later version of Word® to an earlier version. One preferred embodiment for implementing this service is described in connection with FIGS. 8A-8C. Components in FIG. 8A that correspond to those described in connection with FIG. 3 above are designated with corresponding reference numerals.

Operation of the system shown in FIG. 8A will now be described in connection with FIGS. 8B-8C. As described in detail above, the user first logs on to PC 102 via HTTP connections 300 and 301 and navigates to an available services menu for a selected file (step 801).

After selecting e-mail a file as an attachment, as described in connection with FIGS. 7A-7C, a user may preferably select to convert the file to a specified format before it is sent as an e-mail attachment (step 802).

In step 803, PC 102 preferably creates a request to convert the file into the specified format. This request preferably includes the user ID, the data file, and any other parameters needed to complete the request. PC 102 then establishes a secure connection to print services component 120 via connection 850. As described in detail below, print services component 120 may then make an account status request by sending a query to account services component 150. If the status inquiry is unsuccessful, print services component 120 transmits a failure message to PC 102 which forwards it to wireless device 100 via proxy server 104 (step 804). If the account status inquiry is successful, print services component 120 preferably converts the data file (step 805).

After conversion, print manager 122 preferably sends data regarding the type of conversion to account services component 150 for billing and payment purposes (step 806). If billing and payment are unsuccessful, print services component 120 sends a failure message to PC 102 which forwards it to wireless device 100 via proxy server 104 (step 807). If billing and payment are successful, print services component 120 sends the converted file to PC 102 via the established secure connection 850 (step 808).

PC 102 creates an e-mail including any user specified text, and with the converted file as an attachment (step 809). PC 102 then transmits the e-mail message with attachment to the designated recipient 845 via connection 840 (step 810). In step 811, status notification and/or SMS confirmation messages may be transmitted to wireless device 100, as described above.

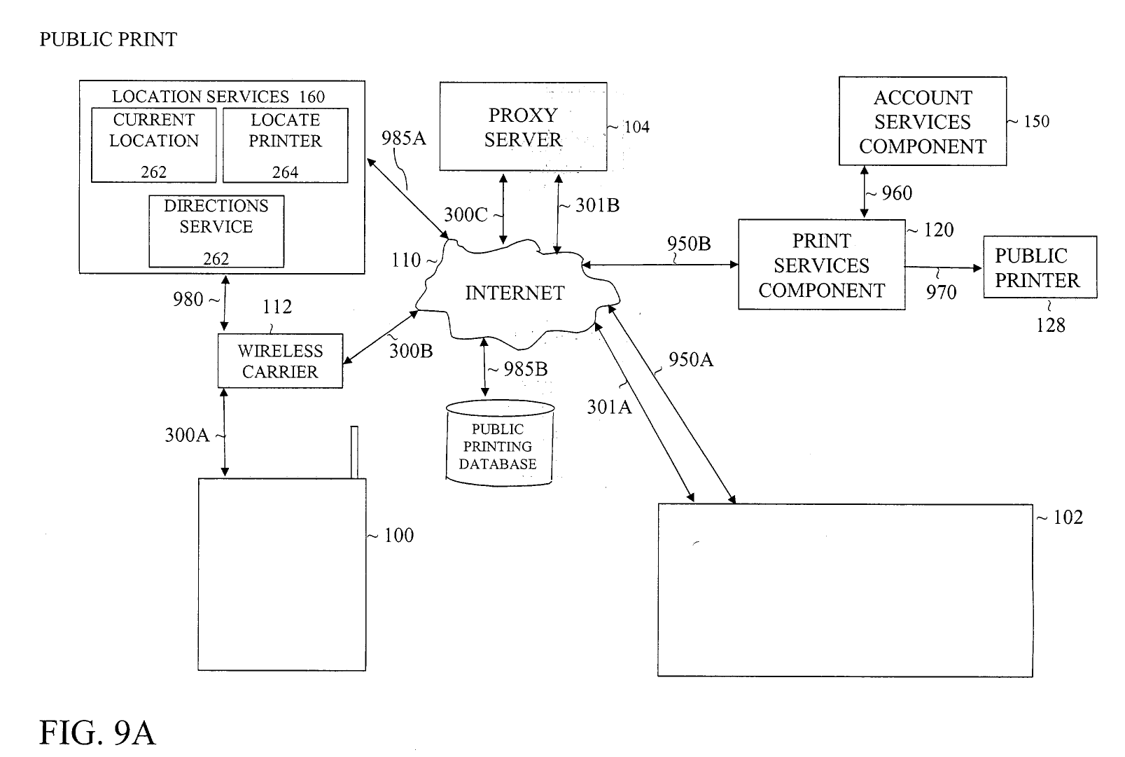

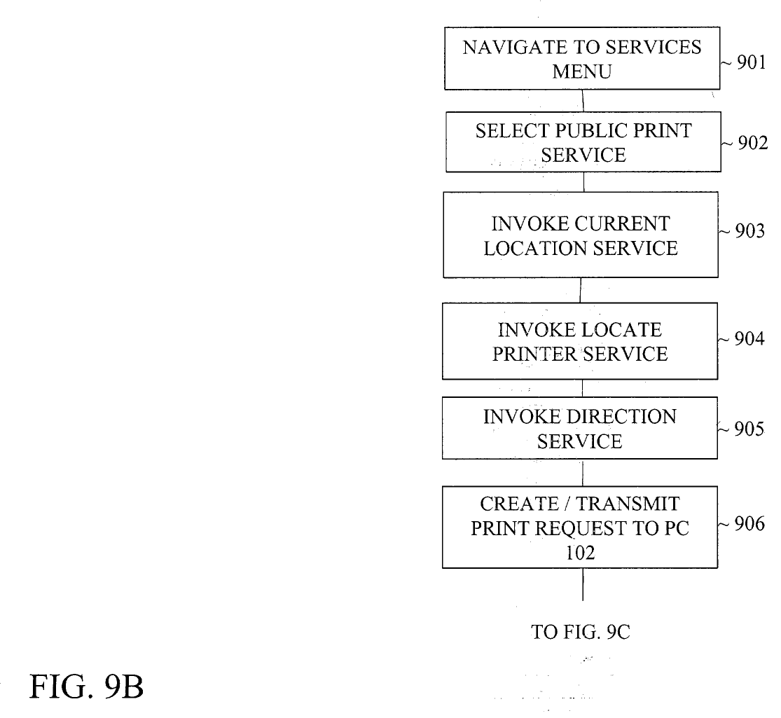

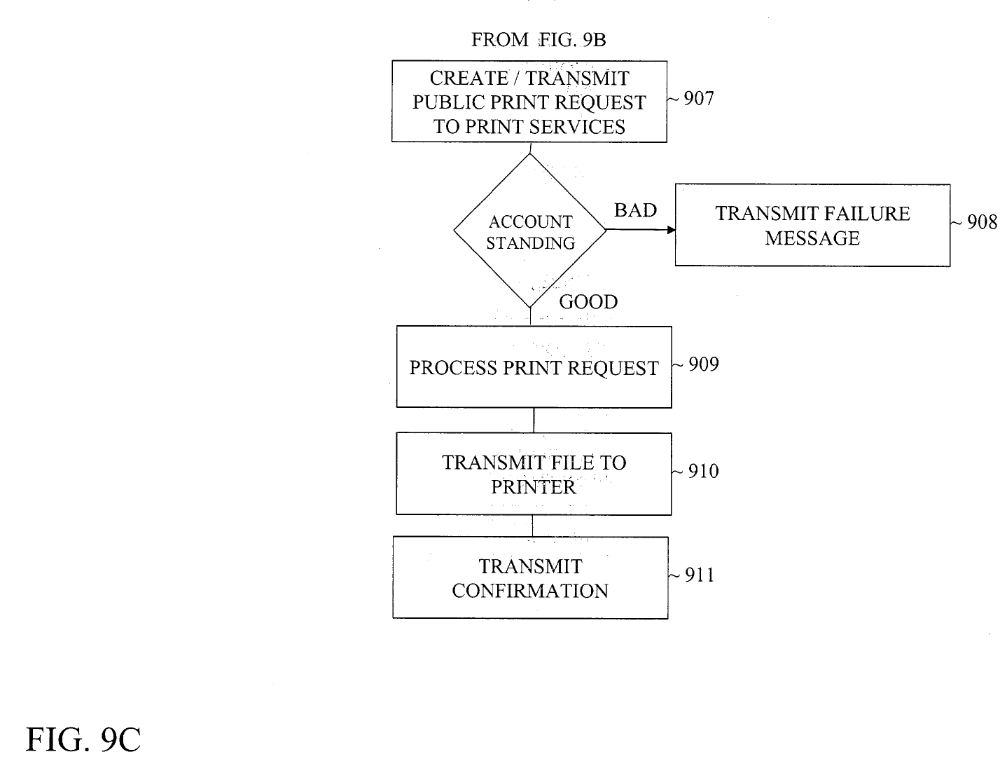

In a preferred embodiment, the present system and method may also provide users with one or more printing services. One such service for printing a file to a public printer is described in connection with FIGS. 9A-C. Components in FIG. 9A that correspond to those described in connection with FIG. 3 above are designated with corresponding reference numerals.

Operation of the system shown in FIG. 9A will now be described in connection with FIGS. 9B-9C. As described in detail above, the user first logs on to PC 102 via HTTP connections 300 and 301 and navigates to a services menu for a selected file (step 901).

In step 902, the user selects the public print service using the wireless device user interface. Via connection 980, wireless device 100 invokes current location service 262 to obtain its current zip code, or other postal or location code, in step 903. In its request to current location service 262, wireless device 100 preferably includes its current location obtained, for example, from embedded GPS capability in wireless device 100. If wireless device 100 does not have embedded GPS capability, or the user wishes to select another location, the user may optionally enter a location directly into the wireless device 100.

In step 904, wireless device 100 invokes locate printer 264 to obtain a list of nearby printers. In its request to locate printer 264, wireless device 100 preferably includes the zip code, or other postal or location code, returned by current location service 262.

Using this zip code, or other postal or location code, locate printer 264 preferably contacts public printing database 278, via connection 985, to generate a list of nearby printers. Additional information may be retrieved at the user request, such as vendor name, printer features, pricing data, etc. This list is transmitted to wireless device 100. The user may select a printer from this list, or may request that additional nearby printers be located.

After the user selects a printer, the user may also request that location services 160 provide directions from their current location to the selected printer. More specifically, in step 905, wireless device 100 invokes direction service 266 to provide directions to the selected public printer.

The wireless device then creates a request to print the selected file at a public printer and transmits the request to PC 102 via proxy server 104 (step 906).

In step 907, PC 102 creates a request to print the file at a public printer and transmits the request to print services component 120 via secure connection 950. The request preferably may include the user ID, the data file to be printed, and any other required parameters. Print services component 120 submits an account status request for the user's account to account status services 150. If the account status inquiry is unsuccessful, print services component 120 transmits a failure message to PC 102 which forwards it to wireless device 100 via proxy server 104 (step 908). If the account status inquiry is successful, print services component 120 preferably prepares the file for printing (step 909). More specifically, print manager 222 forwards the print request along with the desired output parameters, the user ID, and data file to be printed to file printer bit conversion 230.

Printer bit conversion 230 accesses public printing database 278 to determine an acceptable format for public printer 128. After determining the appropriate format, the data file is converted by printer bit conversion 230 into a printer ready file. After conversion, printer bit conversion 230 returns the printer ready file, user ID, and output parameters to print manager 222. As described in detail below, print services component 120 preferably sends data regarding the type of conversion to account services component 150 for billing and payment purposes. If the user has adequate funds available, print manager 222 sends a request to test printer 238 to determine if the public printer is available. Test printer 238 queries the public printer and when the printer becomes available, test printer 238 returns a value of “printer available” to print services component 120.

In an alternative embodiment, test printer 238 periodically queries printers as a background process to determine their availability. For example, test printer 238 may ping one or more printers listed in public printing database 278 each second, minute, hour, or other specified time period. If a ping response is received, the printer is given a status of “printer available”, and if the ping times out, the printer is given a status of “printer unavailable”.

After receiving the “printer available” message, print services component 120 continues processing the printing request by retrieving an appropriate cover page from add cover page 234 and sending the printer ready file along with the cover page to job queue manager 224.

In step 910, job queue manager 224 then sends the cover sheet and printer ready file to public printer 128 for printing. In one preferred embodiment, if PC 102 determines that the service will be completed before the connection between wireless device 100 and proxy server 104 times out, it instructs confirmation service 240 to send a print confirmation notification to PC 102 once the print job has been transmitted to public printer 128. PC 102 forwards the confirmation notification wireless device 100 via proxy server 104 (step 911). Alternatively, if PC 102 determines that the service will not be completed before the connection between wireless device 100 and proxy server 104 times out, print manager 222 sends an “in progress” message to PC 102 which forwards it to wireless device 100 via proxy server 104. Additionally, PC 102 then preferably instructs print services component 120 to send a confirmation message to wireless device 100 via a Short Messaging System (“SMS”) or another text-based messaging service upon completion or failure of the print job.

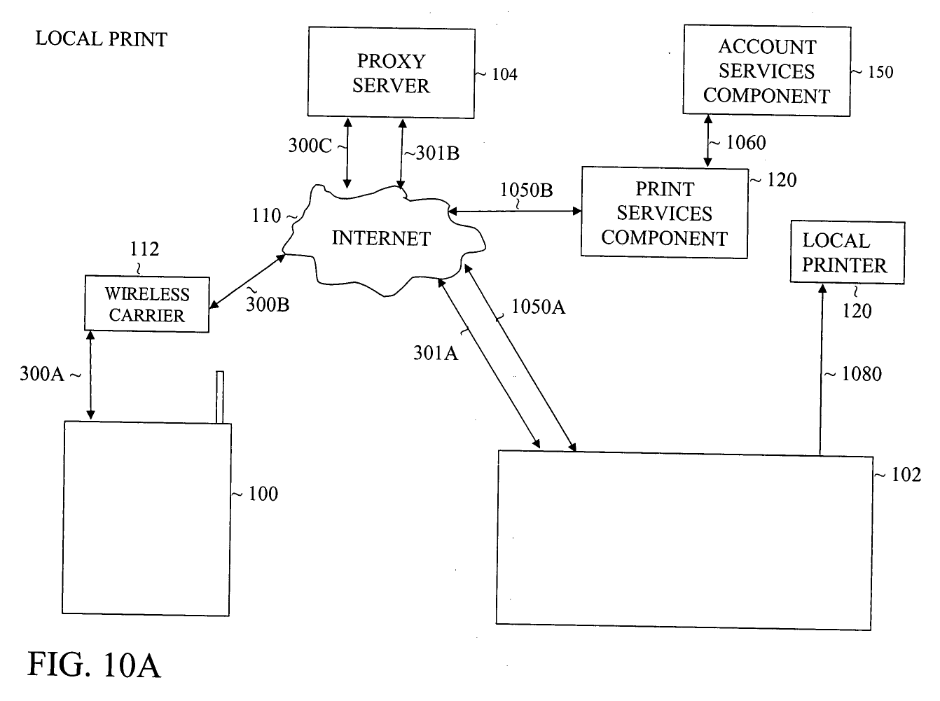

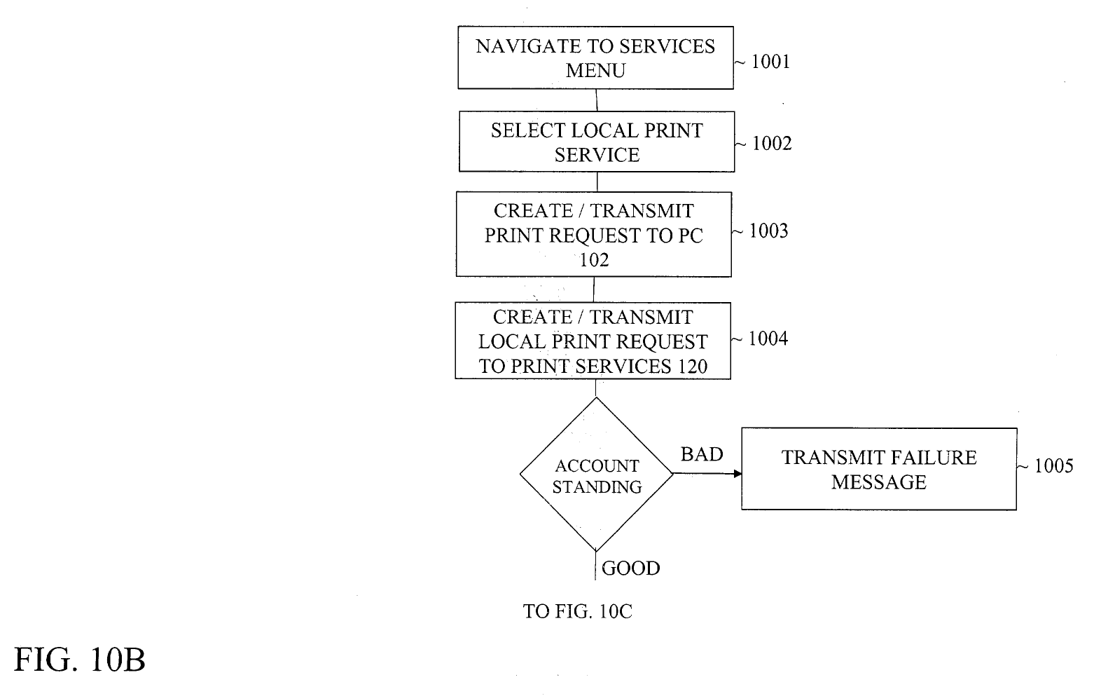

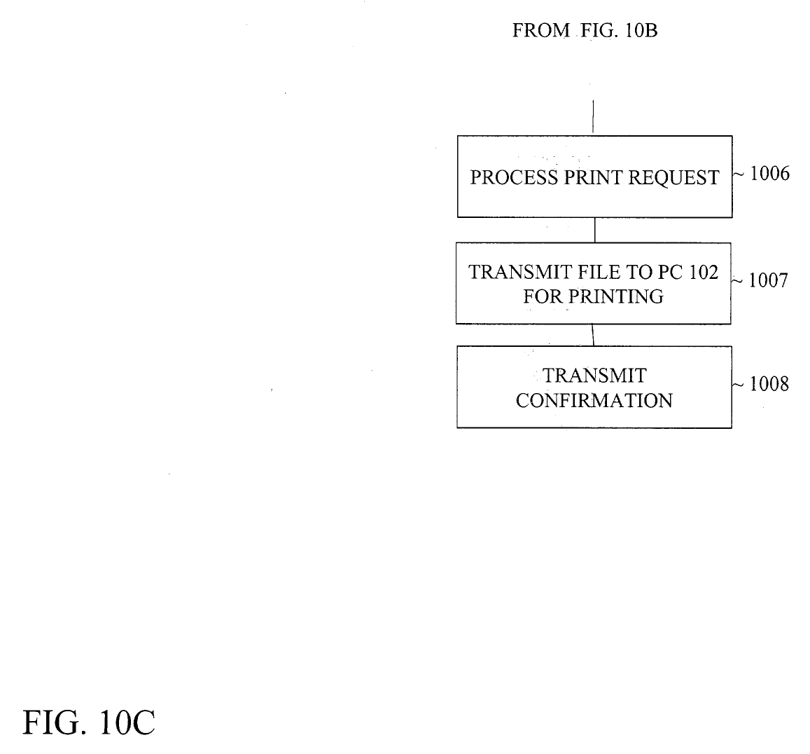

In a preferred embodiment, the present system and method may also enable users to print a selected file at a local output device 108, such as a printer or fax machine, attached directly or via a network to PC 102. One such service for printing a file to a local printer is described in connection with FIGS. 10A-C. Components in FIG. 10A that correspond to those described in connection with FIG. 3 above are designated with corresponding reference numerals.

Operation of the system shown in FIG. 10A will now be described in connection with FIGS. 10B-10C. As described in detail above, the user first logs on to PC 102 via HTTP connections 300 and 301 and navigates to a services menu for a selected file (step 1001).

In step 1002, the user selects the local print service using the wireless device user interface. The wireless device then creates a request to print the selected file at a local printer and transmits the request to PC 102 via proxy server 104 (step 1003). In an enterprise setting, any printer accessible in the enterprise preferably may be selected by PC 102.

In step 1004, PC 102 creates a request to print the file at a local printer and transmits the request to print services component 120 via secure connection 1050. The request preferably may include the user ID, the data file to be printed, and any other required parameters. Print services component 120 submits an account status request for the user's account to account status services 150. If the account status inquiry is unsuccessful, print services component 120 transmits a failure message to PC 102 which forwards it to wireless device 100 via proxy server 104 (step 1005). If the account status inquiry is successful, print services component 120 preferably prepares the file for printing (step 1006). More specifically, print manager 222 forwards the print request along with the desired output parameters, the user ID, and data file to be printed to file printer bit conversion 230.

Printer bit conversion 230 accesses public printing database 278 to determine an acceptable format for local printer 108. After determining the appropriate format, the data file is converted by printer bit conversion 230 into a printer ready file. After conversion, printer bit conversion 230 returns the printer ready file, user ID, and output parameters to print manager 222. As described in detail below, print services component 120 preferably sends data regarding the type of conversion to account services component 150 for billing and payment purposes. If the user has adequate funds available, print services component 120 continues processing the printing request by retrieving an appropriate cover page from add cover page 234 and sending the printer ready file along with the cover page to PC 102 for printing (step 1007).

In one preferred embodiment, if PC 102 determines that the printed file will be completed before the connection between wireless device 100 and proxy server 104 times out, it instructs confirmation service 240 to send a print confirmation notification to PC 102 once the print job is complete. PC 102 forwards to confirmation notification to wireless device 100 via proxy server 104 (step 1008). Alternatively, if PC 102 determines that the service will not be completed before the connection between wireless device 100 and proxy server 104 times out, print manager 222 sends an “in progress” message to PC 102 which forwards it to wireless device 100 via proxy server 104. Additionally, PC 102 then preferably instructs print services component 120 to send a confirmation message to wireless device 100 via a Short Messaging System (“SMS”) or another text-based messaging service upon completion or failure of the print job.

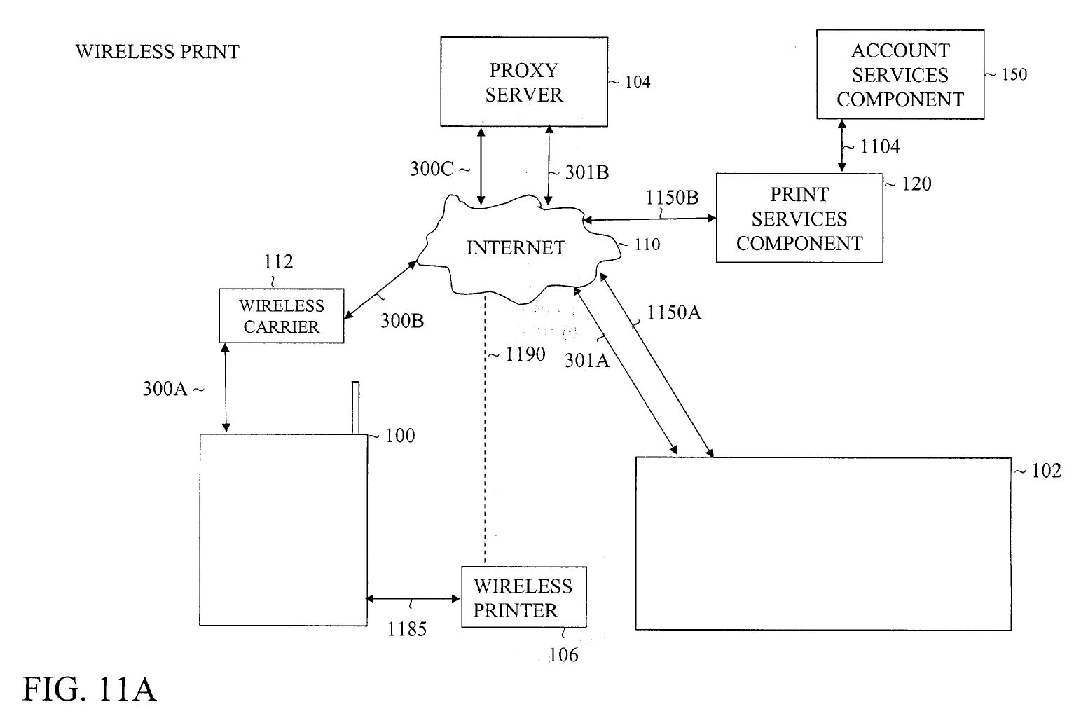

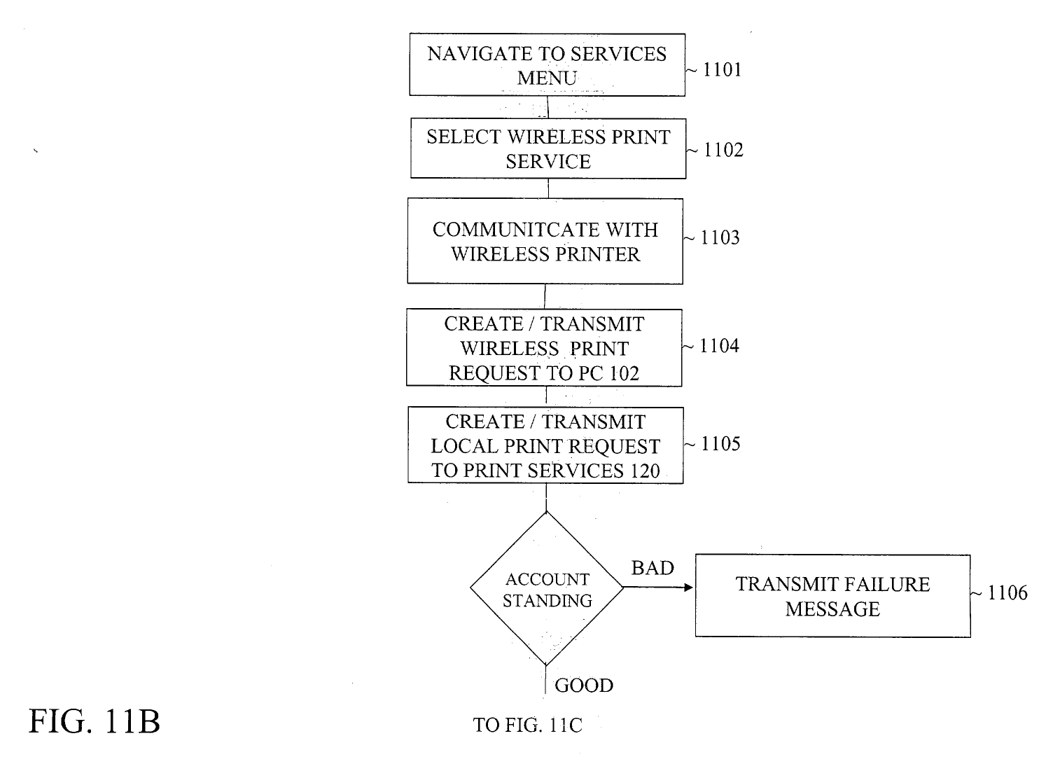

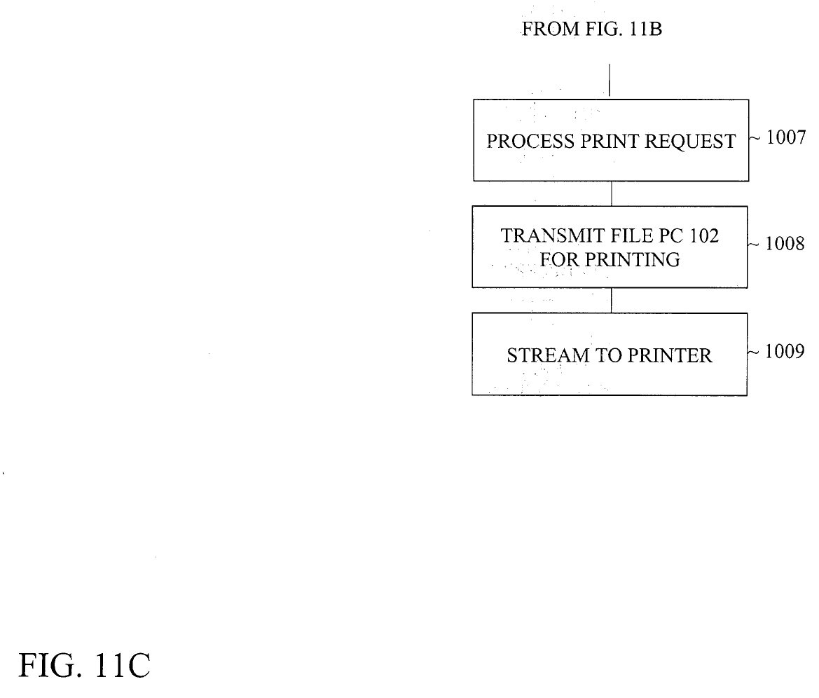

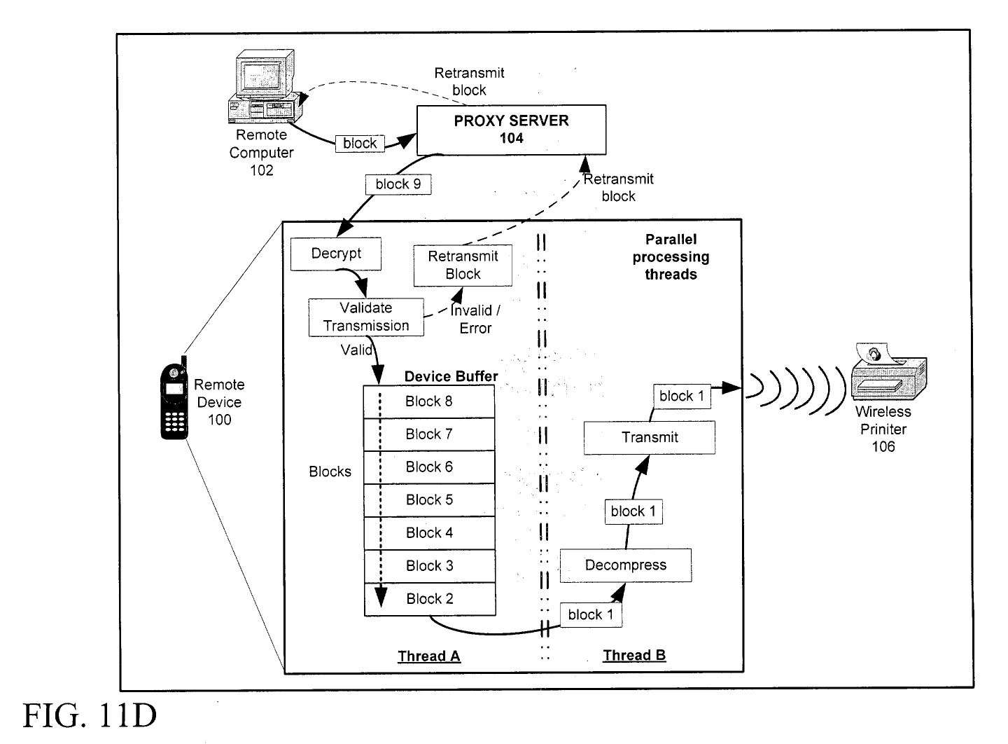

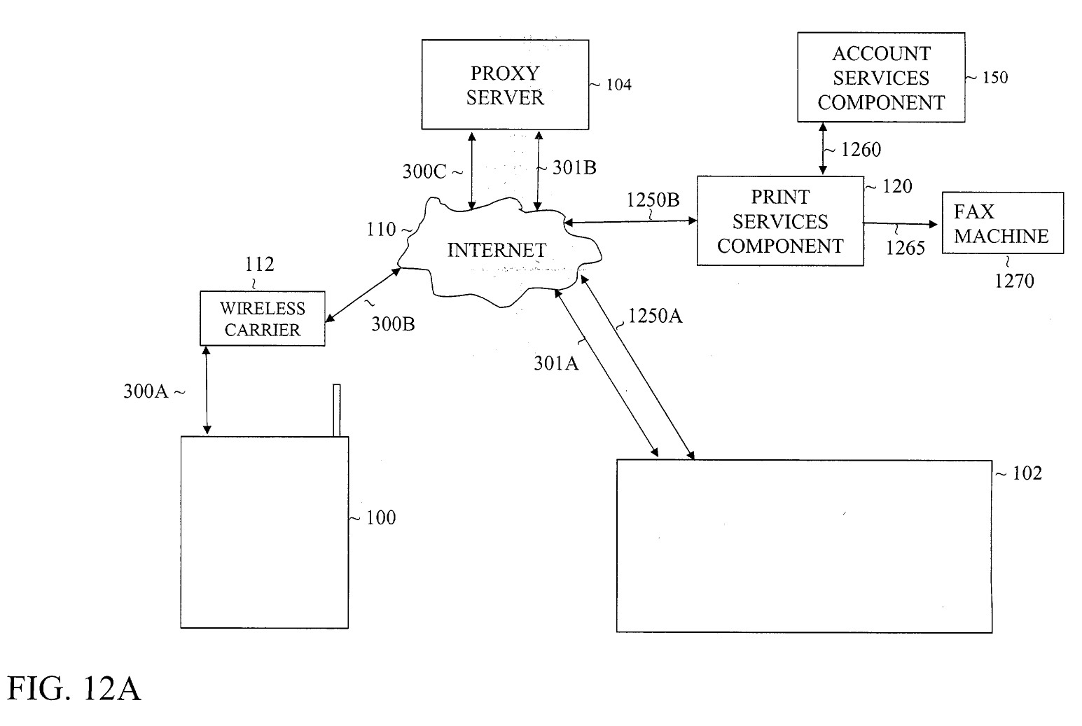

In a preferred embodiment, a third service provided by the present system and method may enable users to print a selected file at a wireless printer 106 near wireless device 100. One such service for printing a file to a wireless printer is described in connection with FIGS. 11A-D. Components in FIG. 11A that correspond to those described in connection with FIG. 3 above are designated with corresponding reference numerals.

Operation of the system shown in FIG. 11A will now be described in connection with FIGS. 11B-11D. As described in detail above, the user first logs on to PC 102 via HTTP connections 300 and 301 and navigates to a services menu for a selected file (step 1101).

In step 1102, the user selects the wireless print service using the wireless device user interface. In step 1103, wireless device 100 preferably communicates with wireless printer 106 and retrieves printer information pertaining to the wireless printer via connection 1185. This information may alternatively be loaded onto a flash memory or other memory device maintained at the printer and adapted to be plugged into wireless device 100. This information may include the printer type, acceptable print formats, print speed, printer routing address, or other printer related parameters, as well as location and other information that may be pertinent for uniquely identifying the usage costs for the printer. The wireless device then creates a request to print the selected file at wireless printer 106 and transmits the request to PC 102 via proxy server 104 (step 1104).

In step 1105, PC 102 creates a request to print the file at wireless printer 106 and transmits the request to print services component 120 via secure connection 1150. The request preferably may include the user ID, the data file to be printed, and any other required parameters. Print services component 120 submits an account status request for the user's account to account services component 150. If the account status inquiry is unsuccessful, print services component 120 transmits a failure message to PC 102 which forwards it to wireless device 100 via proxy server 104 (step 1106). If the account status inquiry is successful, print services component 120 preferably prepares the file for printing (step 1107). More specifically, print manager 222 forwards the print request along with the desired output parameters, the user ID, and data file to be printed to file printer bit conversion 230.

Printer bit conversion 230 accesses public printing database 278 to determine an acceptable format for local printer 108. After determining the appropriate format, the data file is converted by printer bit conversion 230 into a printer ready file. After conversion, printer bit conversion 230 returns the printer ready file, user ID, and output parameters to print manager 222. As described in detail below, print services component 120 preferably sends data regarding the type of conversion to account services component 150 for billing and payment purposes. If the user has adequate funds available, print services component 120 continues processing the printing request by optionally retrieving an appropriate cover page from add cover page 234 and sending the printer ready file along with the cover page to PC 102 for printing (step 1108). Upon completion, print manager 222 preferably compresses the printer ready file and sends the transmission data to account services component 150 for billing and payment purposes. In step 1109, the file is transmitted to wireless printer 106 as described below.

In a preferred embodiment, divides the compressed printer ready file into blocks for transmission to wireless device 100 via proxy server 104, as described above. The wireless device decompresses one data block at a time on a first-in first-out basis.

More specifically, as shown in FIG. 11D, wireless device 100 preferably initiates two parallel processing threads to process data blocks received from PC 102. The first thread preferably sends information to and receives information from PC 102. This thread preferably receives blocks, decrypts them, validates their sequencing, and stores the still compressed block in a data buffer based on a first-in first-out system. The second thread accesses the data buffer and processes the “oldest” block based on a first-in first-out basis. This block is decompressed and transmitted to wireless printer 106. Wireless device 100 transmits one decompressed and decrypted printer-ready block at a time to the wireless printer. As buffer space becomes available, the first thread requests additional blocks from PC 102 until all data blocks have been processed and transmitted. In the event a compressed block is corrupted or is otherwise unusable, the wireless device preferably requests that the block be retransmitted.

In a preferred embodiment, wireless printer 106 resides in a hotel room or other location, and is accessible only via a wireless connection 1185. As described above, information regarding this printer is transmitted to wireless device 100 and is included in the request for wireless printing transmitted to PC 102. The print request is processed, and the processed printer bits are streamed to wireless printer 106 as described above. Charges for printing in this embodiment are preferably handled by account services component 150.

In yet another preferred embodiment, a public printer with wireless communication capabilities resides in a location with limited accessibility, such as a hotel room, but is accessible via a landline-based network. Information regarding printer 106 is transmitted to wireless device 100 and included in the print request transmitted to PC 102. This print request is processed, and may be printed either wirelessly as described above, or the data may be transmitted over one or more networks to printer 106 in a manner analogous to that described in connection with FIG. 9 above. The determination to print wirelessly or over a network may be based on any number of factors such as cost, speed, efficiency, security, or user prerogative. Any charges for printing in this embodiment are preferably handled by account services component 150.

In a preferred embodiment, the present system and method may also provide users with one or more fax services.

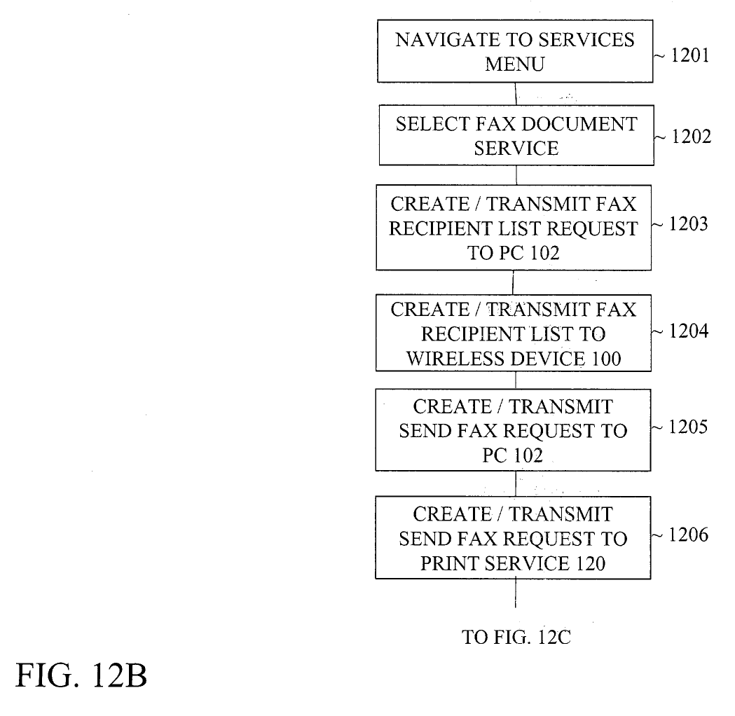

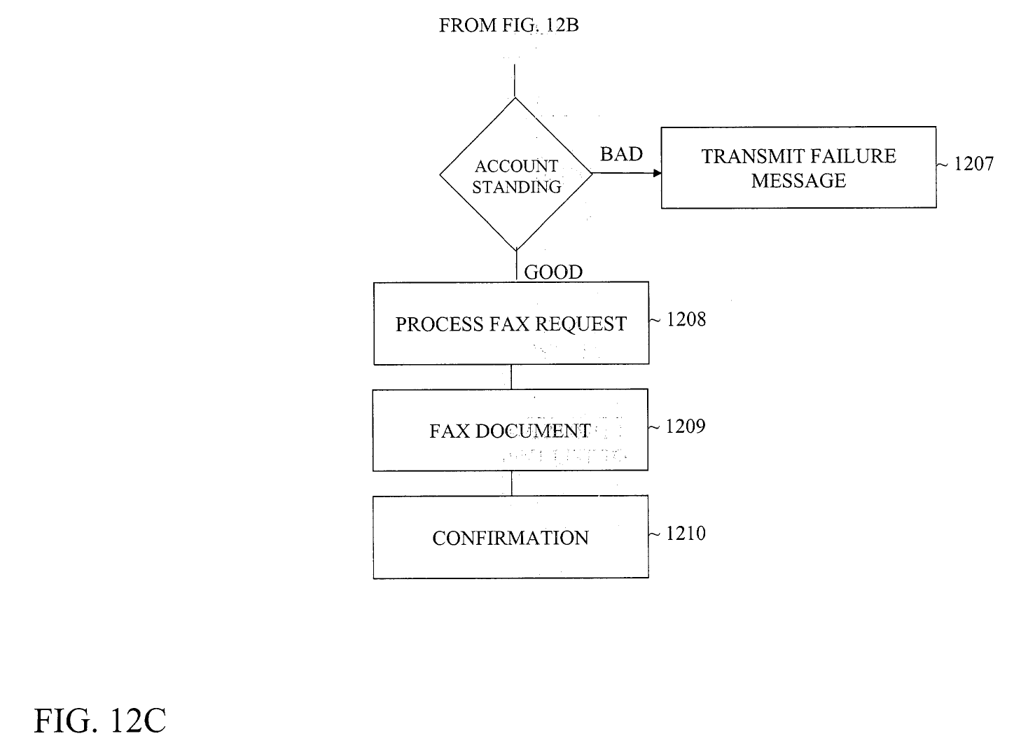

One such service for faxing a document is described in connection with FIGS. 12A-C. Components in FIG. 12A that correspond to those described in connection with FIG. 3 above are designated with corresponding reference numerals.

Operation of the system shown in FIG. 12A will now be described in connection with FIGS. 12B-12C. As described in detail above, the user first logs on to PC 102 via HTTP connections 300 and 301 and navigates to a services menu for a selected file (step 1201).

In step 1202, the user selects the fax document service using the wireless device user interface. Wireless device 100 then preferably generates a request for fax recipient information and related data and sends it to PC 102 via proxy server 104 (step 1203).

PC 102 responds to the request by generating a list of potential fax recipients and sending it to the wireless device for display to the user (step 1204). This list may contain the name, fax number, or other pertinent information of fax recipients.

Using the wireless device interface, the user may scroll through the fax recipient list and select a specific recipient. In another preferred embodiment, the user may input a fax recipient fax number rather than sending a request for a fax recipient information.

In step 1205, wireless device 100 generates a message that includes the selected or input fax recipient and sends it to PC 102 via the proxy server. The message may also include a request by the user to include information on the cover sheet of the fax.

In step 1206, PC 102 creates a request to fax the document to fax server 1270. This request may include the user ID, the data file, and any other parameters needed to complete the request. PC 102 then establishes a secure connection to print services component 120 via connection 1250.

Print services component 120 receives the request and, as discussed in detail below, may then make an account status request by sending a query to account status services 150. If the account status inquiry is unsuccessful, print services component 120 transmits a failure message to PC 102 which forwards it to wireless device 100 via proxy server 104 (step 1207). If the account status inquiry is successful, print services component 120 preferably prepares the document for faxing (step 1208). More specifically, print manager 222 forwards the request along with the desired output parameters, the user ID, and data file to file printer bit conversion 230.

Public printing database 278 is accessed to determine an acceptable format for fax server 1270. After determining the appropriate format, the data file is converted by conversion component 232. After conversion, conversion component 232 returns the fax ready file, user ID, and output parameters to print services component 120.

As described in detail below, print services component 120 preferably sends data regarding the type of conversion to account services component 150 for billing and payment purposes. If the user has adequate funds available, print services component 120 continues with the fax request by retrieving a cover page from add cover page component 234 and sending the fax ready file along with the cover page including any fax message to job queue manager 224.

In step 1209, job queue manager 224 then sends the cover sheet and fax ready file to fax server 1270.

In one preferred embodiment, if PC 102 determines that the fax will be completed before the connection between wireless device 100 and proxy server 104 times out, it instructs confirmation service 240 to send a fax confirmation notification to PC 102 once the fax job is complete. PC 102 forwards to confirmation notification to wireless device 100 via proxy server 104 (step 1210). Alternatively, if PC 102 determines that the service will not be completed before the connection between wireless device 100 and proxy server 104 times out, print manager 222 sends an “in progress” message to PC 102 which forwards it to wireless device 100 via proxy server 104. Additionally, PC 102 then preferably instructs print services component 120 to send a confirmation message to wireless device 100 via a Short Messaging System (“SMS”) or another text-based messaging service upon completion of the fax or a fax transmission failure.

Aspects of account service component 150 operation are now described in more detail. When a user account is initially set up, the account preferably contains parameters such as account status, account balance, available services, payment method, payment frequency, threshold amount, and replenishment amount. The status of the user account preferably may include identifiers such as “good standing”, “active”, “inactive”, “bad standing”, “service suspended”, etc.

In a preferred embodiment, account services component 150 is adapted to maintain user account information, respond to status requests concerning those accounts, and manage billing and payment tasks.

In a preferred embodiment, account manager 252 may be adapted to monitor the balance remaining in an account to determine whether the balance has fallen below a threshold amount. In a preferred embodiment, account manager 252 is authorized by the user to automatically replenish the account when the account balance falls below the threshold. The replenishment amount may be a specified dollar amount (e.g., $100), the amount required to complete a particular print job, or an amount based on the history of the particular user. In a preferred embodiment, this automatic replenishment is accomplished by charging the user's credit card via credit card services 154.

Account manager 252 is also preferably adapted to manage billing associated with print and non-print service provided by the present system. With respect to non-print services, the account manager 252 preferably determines the fee to be charged based on information provided by print manager 222. This information may include cost information for services such as document conversion, faxing, messaging, or any other fee-based service provided by print services component 120.

By contrast, with respect to print services 120, account manager 252 preferably determines fee amounts by accessing public printing database 278 to retrieve the print job fee schedule for the printer to which the job is delivered. As described above, the print job fee schedule preferably includes parameters such as printing costs per page, page size, for color or black and white printing, for laser or inkjet printing, and for duplex printing. It may also include information concerning costs for document conversion based on file size or format, vendor terms, discounts, promotions, fees, and any other parameters specific to the user request. Account manager 252 uses the fee schedule and the service charge details to determine the amount due for a particular print job. Account manger 252 preferably may be enabled to transfer funds automatically, periodically or upon request to authorized users 270, e.g. a particular vendor, based upon funds generated by that vendor.

Amounts due for services rendered are preferably determined by account manager 252 and deducted from appropriate user accounts. In a preferred embodiment, each time a user requests a service, print services manager 222 transmits an appropriate message to account manager 252 so that the user may be charged. If the user account has sufficient funds, a reply is sent to the print manager indicating payment.

If the user account has insufficient funds, a replenishment request, as described above, may be sent to post charge service 156. In a preferred embodiment, this payment is accomplished by charging the user's credit card via credit card services 154. When the amount charged to the user's credit card posts to the account successfully, the account status identifier is updated to reflect payment, and holds a value of “good standing”. The amount is deducted from the user account, and a reply is sent to print manager 222 indicating payment. If the amount due is declined, delayed, or not approved for any reason, the account status identifier is updated to reflect nonpayment, and the identifier holds a value of “service suspended”. A reply indicating nonpayment is also returned to the print manager.

Account manager 252 preferably is enabled to accept input from authorized users 270. For example, if view usage 186 sends a request to account manager 252, account manager 252 can fulfill that request by accessing any databases needed, such as public printing database, customer account database, etc. Further, account manager 252 preferably accepts credit requests from post job credit 288. These requests allow account manager to access customer account database 274 to apply a charge back or credit for debited services that are incomplete.

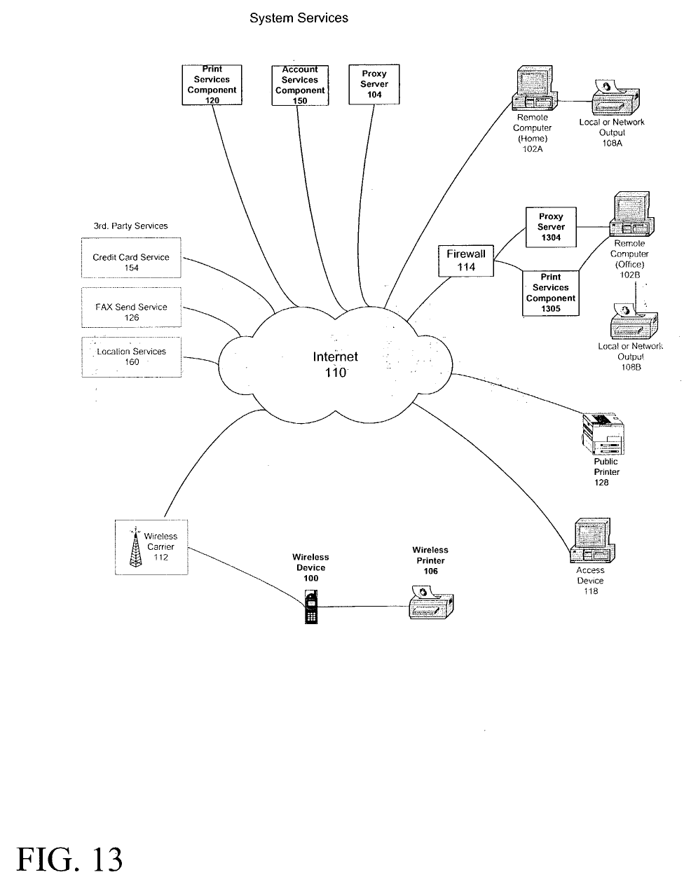

An alternative preferred embodiment of the present system suitable for use as an enterprise solution is shown in FIG. 13. As will be recognized, the system of FIG. 13 is analogous to that of FIG. 1 except that an additional proxy server 1304 and an additional printer services component 1305 are provided behind firewall 114. In this preferred embodiment, proxy server 1304 and printer services component 1305 are preferably owned or maintained by the entity that maintains firewall 114 and these components are reserved for use by users employed by or permitted to use the resources of that entity. As will be recognized, proxy server 1304 may be used to provide services analogous to those described above in connection with proxy server 104, and printer component services may be used to provide services analogous to those described in connection with printer services component 120.

In a preferred embodiment, print services component 1305 is adapted to communicate with print services component 120 when a user wishes to print a document on a public printer or send a fax (e.g., if the capability to send a fax using a compatible enterprise fax server does not exist within the enterprise). In particular, print services component 1305, forwards a file for public printing or if the entity does not provide their own fax services, for faxing to printer services component 120 which processes it as described above and forwards details of the print job to account services component 150 so that the account of the enterprise may be billed for the service.

It should be recognized that the computer processes described above are tailored to connect a wireless device 100 and a PC 102. One skilled in the art will be able to design suitable computer processes necessary to implement other connections. For example, one skilled in the art may design a system suitable to connect one remote computer to another, or any other wireless or wired access device to a PC 102.

While the invention has been described in connection with specific embodiments, it is evident/that numerous alternatives, modifications, and variations will be apparent to those skilled in the art in light of the foregoing description.

1. A method for facilitating user access from a wireless device to one or more resources stored on or accessible from a remote computing device, the computing device comprising: one or more input devices; one or more desktop applications, each desktop application comprising a user interface for accessing functionality associated with the application via at least one of the one or more input devices; and a software program comprising a communication component having no user interface accessible via the one or more input devices and being accessible solely via communication with a proxy server; the method comprising:
transmitting a resource list from the computing device to the wireless device via a proxy server, the resource list comprising identifiers for each of one or more resources that identify the resource without identifying the location where the resource is stored;
transmitting a message from the wireless device to the computing device via the proxy server, the message representing a request for a service in connection with a selected resource; and
performing the requested service without launching the one or more desktop applications.

2. The method of claim 1, wherein the service is to transmit the selected resource via electronic mail to a destination address.

3. The method of claim 2, further comprising the steps of:
the communication component retrieving the selected resource, constructing an electronic mail message including the selected resource, and transmitting the electronic mail message to the destination address.

4. The method of claim 2, further comprising the steps of:
converting the selected resource from a first format to a second format; and
the communication component constructing an electronic mail message including the selected resource in the second format, and transmitting the electronic mail message to the destination address.

5. The method of claim 1, wherein the service is to print the resource at a printer accessible by the computing device.

6. The method of claim 5, wherein the printer is a local printer accessible by the computing device.

7. The method of claim 5, wherein the printer is a network printer accessible by the computing device via a network.

8. The method of claim 5, further comprising the steps of:
the communication component retrieving the selected resource and forwarding it to a print service component;
the print service component formatting the resource for printing;
the print service component transmitting the formatted resource to the computing device; and
the computing device transmitting the formatted resource to the printer for printing.

9. The method of claim 1, wherein the service is to print the resource at a public printer.

10. The method of claim 9, further comprising the steps of:
the communication component retrieving the selected resource and forwarding it to a print services component;
the print service component formatting the resource for printing; and
the print service component transmitting the formatted resource to a public printer.

11. The method of claim 10, further comprising the steps of: determining the location of the wireless device;
identifying one or more public printers within a predetermined distance of the determined location;
selecting by the user a public printer from the identified one or more public printers; and
the print service component transmitting the formatted resource to the selected public printer.

12. The method of claim 11, wherein the location of the wireless computing device is determined using global positioning means.

13. The method of claim 11, wherein the location of the wireless computing device is determined using user input.

14. The method of claim 1, wherein the service is to print the resource at a printer accessible by the wireless device.

15. The method of claim 14, wherein the printer is a wireless printer.

16. The method of claim 15, wherein the printer is an infrared enabled printer.

17. The method of claim 15, wherein the printer is a radio frequency enabled printer.

18. The method of claim 14, wherein the printer is accessible via a wired connection to the wireless device.

19. The method of claim 14, further comprising the steps of:
the communication component retrieving the selected resource and forwarding it to a print service component;
the print service component formatting the resource for printing;
the print service component transmitting the formatted resource to the computing device;
the computing device transmitting the formatted resource to the wireless device via the proxy server; and
the wireless device transmitting the formatted resource to the printer.

20. The method of claim 1, wherein the service is to transmit the resource as a fax to a fax machine.

21. The method of claim 1, wherein the wireless device communicates with the proxy server via an HTTP connection.

22. The method of claim 1, wherein the computing device communicates with the proxy server via an HTTP connection.

23. The method of claim 22, further comprising the steps of:
the computing device periodically polling the proxy server;
the proxy server determining whether data intended for the computing device has been received from the wireless device;
if data intended for the computing device has been received, immediately transmitting said data in a polling response to the computing device; and
if data intended for the computing device has not been received, transmitting an empty polling response to the computing device after some predetermined time.

24. The method of claim 22, further comprising the steps of:
the wireless device waiting for a response from the computing device;
determining whether data intended for the wireless device will be ready for transmission to the wireless device before the connection between the wireless device and the proxy server is closed;
if data intended for the wireless device will be ready for transmission before the connection between the wireless device and the proxy server will be closed, transmitting the data from the computing device to the wireless device via the proxy server; and
if data intended for the wireless device will be ready for transmission after the connection between the wireless device and the proxy server will be closed, transmitting a message from the computing device to the wireless device via the proxy server, said message containing an in progress notification.

25. The method of claim 1, further comprising:
establishing an account for the user;
depositing value in the account;
billing said account for services provided;
monitoring the value remaining in the account; and
replenishing the account when the remaining value falls below a predetermined amount.

26. The method of claim 25, wherein the step of replenishing comprises automatically replenishing the account by charging a credit card of the user.

27. The method of claim 25, wherein the step of replenishing comprises automatically replenishing the account by withdrawing funds from an account maintained by the user with a financial institution.

28. The method of claim 25, wherein the step of replenishing comprises transmitting an invoice to the user and receiving funds for deposit in the account.

29. The method of claim 1, further comprising:
identifying a vendor that participated in providing a requested service;
automatically crediting an account of the vendor for its participation.

30. The method of claim 29, wherein the step of identifying a vendor comprises identifying the vendor associated with a printer ID of a printer to which a print job is transmitted.

31. A method for transmitting data to a wireless device comprising:
dividing the data into blocks, each block having a size, the size being determined as a function of one or more physical characteristics of the wireless device; and
transmitting the blocks to the wireless device.

32. The method of claim 31, wherein the blocks are transmitted sequentially.

33. The method of claim 31, wherein the one or more physical characteristics comprise memory capacity of the wireless device.

34. The method of claim 31, wherein the data comprises a print job and further comprising the wireless device transmitting printer ready bits derived from the blocks to a printer for printing.

35. The method of claim 31, wherein the data is compressed before it is divided into blocks, and is decompressed by the wireless device.

36. The method of claim 31, wherein the wireless device controls delivery of the blocks.

37. The method of claim 36, wherein the wireless device delays a request for a next block to accept a second transmission, and recommences transmission of the blocks by requesting the next block upon completion of the second transmission.

38. A method for communicating a confirmation message to a wireless device regarding a requested service, comprising:
determining a first time amount, the first time amount representing the time a connection to a wireless device is likely to remain available;
determining a second time amount, the second time amount representing the time it is likely to take to complete the requested service;
if the first time amount is greater than the second time amount, transmitting the confirmation message via the connection to the wireless device; and
if the second time amount is greater than the first time amount, transmitting the confirmation message via an alternate communication means.

39. The method of claim 38, wherein the alternate communication means is a short message service.

40. A method for increasing the number of connections that can be handled by a proxy server, comprising:
determining a time amount that a connection can remain idle between the proxy server and a computing device;
receiving a polling request from the computing device at the proxy server; and
responding to the polling request when the time amount has passed.

41. The method of claim 40, wherein the step of determining comprises incrementally increasing the time before the proxy server transmits a response to polling requests from the computing device until the delay results in a disconnection.

42. The method of claim 1, wherein the computing device is assigned a unique numeric identifier comprising a plurality of fields.

43. The method of claim 42, wherein the user may configure a program on the wireless device to communicate with the computing device via the proxy server without inputting non-numeric characters corresponding to a DNS entry or navigating via a web-based interface using input mechanisms of the wireless device.

44. The method of claim 42, wherein the user enters the unique numeric identifier on the wireless device during configuration, the identifier being used to derive connection information regarding the proxy server.

45. The method of claim 42, wherein the unique numeric identifier is used to derive a host name for the proxy server.

46. The method of claim 42, wherein the unique numeric identifier contains a check sum field.

47. The method of claim 43, wherein once the program is configured, the user can launch the program and connect to the proxy server via an HTTP connection without:
inputting the unique numeric identifier each time a connection is established;
inputting non-numeric characters corresponding to a DNS entry; or
navigating via a web-based interface using the wireless device input mechanisms.

48. A method for connecting a computing device to a proxy server, said computing device being provided with a unique numeric identifier comprising a plurality of fields, the method comprising:
establishing a HTTP connection between the computing device and the proxy server using a DNS entry derived from the plurality of fields and a DNS domain name selected from a plurality of DNS domain names provided to the computing device;
establishing subsequent HTTP connections between the computing device and the proxy server using DNS entries derived from the plurality of fields and others of the DNS domain names provided to the computing device;
wherein each DNS entry resolves to the same proxy server.

49. A method for authenticating a data message transmitted from a wireless device to a computing device via a proxy server, comprising:
using at least a portion of a password entered by a user to generate an encryption key;
encrypting a message with the encryption key;
transmitting the encrypted message from the wireless device to the computing device via the proxy server;
the computing device using the at least a portion of the password to generate a decryption key;
decrypting the encrypted message by the computing device using the decryption key; and
determining if the decrypted message contains valid data.

50. The method of claim 49, wherein valid data comprises a valid system command at a predefined location in the data message.

51. A system for facilitating user access to one or more resources, comprising:
a proxy server;
a wireless device adapted to establish a communication link with the proxy server;
a computing device comprising one or more input devices, one or more desktop applications, each desktop application comprising a user interface for accessing functionality associated with the application via at least one of the one or more input devices, and a software program comprising a communication component having no user interface accessible via the one or more input devices and being accessible solely via communication with the proxy server, the computing device being adapted to transmit a resource list to the wireless device via the proxy server, the resource list comprising identifiers for each of one or more resources that identify the resource without identifying the location where the resource is stored and adapted to receive a message from the wireless device via the proxy, the message representing a request for a service in connection with a selected resource.
